(19) United States
(12) Patent Application Publication
(10) Pub. No.: US 2025/0353739 A1
(43) Pub. Date: Nov. 20, 2025

(54) A PIEZO PHOTOCATALYTIC PROCESS FOR THE PRODUCTION OF HYDROGEN FROM WATER

(71) Applicant: NEWSOUTH INNOVATIONS PTY LIMITED, Sydney, New South Wales (AU)

(72) Inventors: Yue Jiang, Sydney, New South Wales (AU); Charles Christopher Sorrell, Sydney, New South Wales (AU); Pramod Koshy, Sydney, New South Wales (AU); Danyang Wang, Sydney, New South Wales (AU)

(21) Appl. No.: 18/869,235

(22) PCT Filed: May 26, 2023
(86) PCT No.: PCT/AU2023/050445

§ 371 Date: Nov. 25, 2024

(30) Foreign Application Priority Data
May 27, 2022 (AU) 2022901443

(51) Int. Cl. C01B 3/04; B01J 19/10; B01J 19/12; B01J 23/02; B01J 35/39; B01J 37/18

(52) U.S. Cl. CPC C01B 3/042; B01J 19/10; B01J 19/123; B01J 23/02; B01J 35/39; B01J 37/18; B01J 2219/0877; B01J 2219/0892; B01J 2219/1203

(57) ABSTRACT

The present invention is directed to piezo photocatalytic process for the production of hydrogen from water, wherein the process comprises the steps of: (a) providing non-metal-doped barium titanate which includes at least one defect; (b) contacting the non-metal-doped barium titanate provided in step (a) with water to form a mixture; and (c) subjecting the mixture formed in step (b) to: (i) actinic radiation; and (ii) mechanical force, to produce hydrogen from the water, as well as non-metal-doped barium titanate and methods of production thereof.

### FIELD

The present invention relates to the production of hydrogen from water. The process is a piezo photocatalytic process that uses a specific non-metal-doped barium titanate, preferably a reduced non-metal-doped barium titanate.

### BACKGROUND

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

To combat climate change and secure sustainable clean energy resources, one possible solution that is under extensive discussion is the hydrogen economy. Hydrogen as a sustainable energy resource is a promising alternative to traditional fossil fuels because of its high energy density of 142 MJ/kg and zero carbon emissions. Water splitting is a promising pathway to achieve efficient production of hydrogen gas at an industrial and economic scale, owing to its good energy conversion and storage capabilities. However, water splitting is only a viable option due to the critical role played by catalysts.

Current catalyst-driven water splitting technologies require highly pure water sources. Whilst pure water is readily available in laboratory settings, such requirements become significantly limiting in industrial settings, considering the limited freshwater sources globally and the high costs (both energy and fiscal) associated with water purification. Additionally, there is generally poor availability of suitable water resources in areas where sunlight for solar-driven catalytic water splitting may be particularly suited. This scenario is the reality in Australia which has low freshwater resources, yet an abundance of arid regions which experience long and regular durations of high sunlight intensities that are particularly suitable for photocatalysts. However, Australia does have high volumes of seawater and brackish ground water resources which could be potentially used for water splitting, if a suitable catalyst was available. Sea water (or brackish water) could be purified prior to use, for example by reverse osmosis. However, this would require high energy and fiscal costs and largely nullify the advantages of using sea water.

Hence there is an ongoing need for improved processes to produce hydrogen from readily available water sources, such as sea water. Such processes need to be efficient, cost-effective, suitable for large-scale applications and limited in their environmental impact. Processes requiring catalysts which are harder to produce and/or contain toxic elements are obviously less suitable for large-scale applications. Use of photocatalysts which can utilise a wider range of light frequencies can result in improved processes, for example due to the greater amount of available energy from a given light source such as sunlight or greater flexibility generally in the source of the light.

Sea water is the most abundant aqueous feedstock on earth but there are specific challenges that affect the viability of direct seawater splitting, as compared to the splitting of pure water. The largest issue is the presence of salt (sodium chloride) and other ions in the water. These ions complicate the electrochemistry of hydrogen production. One common concern is to avoid the production of chlorine at the anode. This can happen due to the similarity of the electrochemical potentials of the oxygen evolution reaction (OER) at 1.23 eV and the chlorine evolution reaction (CER) at 1.72 eV. Another issue is that seawater inherently contains electron scavengers, such as Na⁺, and hole scavengers, such as Cl⁻. These affect the electrochemistry at the surface of any catalyst. Solutions and learnings developed for splitting of pure water may not be relevant or applicable to the efficient splitting of sea water.

Finally, the microorganisms and other organic matter inevitably present in non-purified water sources like sea water could alter the catalytic process, leading to undesirable side-reactions, or foul and deactivate the catalyst. The preceding risks clarify the desirability of using purified water for water splitting but they also highlight the desirability of developing catalysts for green, sustainable, efficient, and reliable seawater splitting.

One option for hydrogen production is solar-driven sea water splitting using semiconductor photocatalysts, but current processes typically have limited energy conversion efficiencies. Accordingly, there is a constant need for improved processes utilising catalysts that are more efficient in splitting non-pure water sources to produce hydrogen gas. In particular, there is a need for photocatalyst which are better able to produce hydrogen gas from sea water or brackish water sources when the catalyst is illuminated with actinic radiation, such as sunlight or light from a LED.

Accordingly, there is a need for a catalyst that is more efficient in splitting non-pure water sources to produce hydrogen gas, particularly a photocatalyst that is capable of producing hydrogen gas from seawater or brackish water sources when the catalyst is illuminated with actinic radiation, such as sunlight.

It is an object of the present invention to overcome or ameliorate one or more the disadvantages of the prior art, or at least to provide a useful alternative.

### SUMMARY OF INVENTION

In a first aspect of the present disclosure, there is provided a piezo photocatalytic process for the production of hydrogen from water, wherein the process comprises the steps of:
(a) providing non-metal-doped barium titanate which includes at least one defect;
(b) contacting the non-metal-doped barium titanate provided in step (a) with water to form a mixture; and
(c) subjecting the mixture formed in step (b) to:
   (i) actinic radiation; and
   (ii) mechanical force,
   to produce hydrogen from the water.

As the skilled person would appreciate, BTO (barium titanate) is a known semiconductor material with a bandgap of about 3.5 eV. However, such a large band gap limits the use of this material in photocatalytic applications, as higher-energy UV light is required at such band gaps. Accordingly, it is an advantage of the present invention that the band gap of the BTO-based photocatalyst is lowered, to allow for broader, or lower intensity light sources to be used. For instance, at a band gap equal to or less than about 3 eV, some visible light, and all UV light, is able to be used to activate the photocatalyst upon absorption. Therefore, solar radiation, white light sources and UV lamps, for instance, can be used with the catalyst of the present invention.

As the skilled person would appreciate, the band gap for a semiconductor material is defined by the vacant conduction band (CB) energy (i.e., the lowest unoccupied electron state) and the top of the filled valence band (VB) (i.e., the highest occupied electron state). The band gap of the BTO-based photocatalyst of the present disclosure is defined by a CB that is greater than 0 eV and a VB that is less than 1.23 eV. The CB may be between about 0 eV and −1 eV, or between about −0.1 eV and about −0.75 eV, or between about −0.25 eV and about −0.5 eV, or it may be about 0, −0.05 −0.1, −0.15, −0.2, −0.25, −0.3, −0.35, −0.4, −0.45, −0.5, −0.55, −0.6, −0.65, −0.7, −0.75, −0.8, −0.85, −0.9, −0.95, −1.0, −1.05, −1.1, −1.15, −1.2, −1.25, −1.3, −1.35, −1.4, −1.45, −1.5, −1.55, −1.6, −1.65, −1.7, −1.75, −1.8, −1.85, −1.9, −1.95 or −2.0 or any range therein. The VB may be between about 1.23 eV and about 2.23 eV, or between about 1.30 eV and about 1.90 eV, or between about 1.50 eV and about 1.80 eV, or it may be about 1.23, 1.24, 1.25, 1.26, 1.27, 1.28, 1.29, 1.30, 1.35, 1.40, 1.45, 1.50, 1.55, 1.60, 1.65, 1.70, 1.75, 1.80, 1.85, 1.90, 1.95, 2.00, 2.05, 2.10, 2.15, 2.20, 2.21, 2.22 or 2.23 eV, or any range therein. In one embodiment, the CB may be about-0.91 eV and the VB may be about 2.05 eV, leading to a band gap of about 2.96 eV.

Without being bound to theory, the inventors understand that the BTO-based photocatalyst of the present disclosure has a lowered band gap due to the presence of at least one defect type that is present in the crystalline structure of BTO. As the skilled person will appreciate, defects to regular crystalline structures can alter the energy band diagram, potentially leading to improvements in performance. However, the effect of defects on the band gap and other material properties is not generally predictive. Surprisingly, the inventors have found that when certain defects are introduced into BTO, the result is a band gap of about 3 eV. The defect or defects may consist of an oxygen vacancy (where an oxygen is removed from the crystal structure), reduction of a metal ion (for example, the reduction of a Ti(IV) ion to a reduced form, including a Ti(III) ion, a Ti(II) ion or a Ti(0) atom), Frenkel defects (which consist of point defects whereby a charge-compensated cations and anions leave their lattice sites and are located in the interstices, thereby disrupting the long-range order of the crystal), Schottky defects (which consist of point defects whereby charge-compensated cations and anions leave their lattice sites and exit the crystal structure, or any combination thereof. In some preferred embodiments, the BTO-based photocatalyst of the present disclosure contains both oxygen vacancies and at least one reduced Ti ion. As the skilled person would appreciate, in order to maintain the overall charge of the material, for each oxygen vacancy either two Ti(IV) ions are reduced to Ti(III), or one Ti(IV) ion is reduced to Ti(II), or one Ti(II) ion is reduced to a Ti(0) atom (i.e., reduction of a Ti(IV) ion to a Ti(0) atom requires two oxygen vacancies). In other words, the BTO-based photocatalyst of the present disclosure may contain oxygen vacancies, and/or Ti(III) ions, and/or Ti(II) ions, and/or Ti(0) atoms.

In some embodiments, the at least one defect may be an oxygen deficiency, a reduced Ti ion (Ti^{<4+}), or may comprise a combination thereof. In embodiments where the at least one defect comprises or is an oxygen vacancy, the non-metal-doped barium titanate may comprise oxygen vacancies at a concentration of up to 25 at %, or up to about 20 at %, or up to about 15 at %, or up to about 10 at %, or at least 5 at %, or at least 10 at %, or at least about 15 at %, or at least about 20 at %, or between about 5 and 25 at %, or between about 7.5 and 22.5 at %, or between about 10 and 25 at %, or between about 15 and 20 at %, or between about 10 and 20 at %, or may be about 5, 6, 7, 8, 9, 10, 11, 12, 13, 14, 15, 16, 17, 18, 19, 20, 21, 22, 23, 24 or 25 at %, where “at %” is the atomic percent. In some embodiments where the defect comprises or is a reduced Ti ion (Ti^{<4+}), the or each reduced Ti ion may be Ti³⁺, or Ti²⁺, or Ti⁰. When reduced Ti ions are present, they may be present at a Ti⁴⁺:Ti^{<4+} ratio of from 5.0:1 to 15:1, such as from 5:1 and 10:1, or from 5:1 and 12:1, or from 7:1 and 12:1, or from 10:1 and 15:1, or about 5:1, 6:1, 7:1, 8:1, 9:1, 10:1, 11:1, 12:1, 13:1, 14:1 or 15:1.

The defects that provide the BTO-based catalyst of the present disclosure with the advantageous features described herein are introduced into the BTO crystal structure. The defects may be introduced through a post-processing step carried out after crystallisation, or they may be introduced during crystal formation. The inventors have found that the beneficial defects can be introduced into the BTO material by exposure to a reducing atmosphere. In one embodiment, the reducing atmosphere comprises hydrogen gas (H₂). As a 100% hydrogen gas atmosphere would be dangerous when heated, it may be mixed with a noble gas or an inert gas. For instance, the hydrogen gas may be mixed with neon, argon, krypton, xenon, carbon dioxide, nitrogen or any other suitable inert or non-reactive gas. In one preferred embodiment, the reducing atmosphere may comprise between about 1% v/v and 10% v/v hydrogen gas (or between about 2% v/v and about 8% v/v, or between about 4% v/v and about 6% v/v, or about 1, 2, 3, 4, 5, 6, 7, 8, 9 or 10% v/v or any range therein) and between about 90% v/v and 99% v/v argon gas (or between about 92% v/v and about 98% v/v, or between about 94% v/v and about 96% v/v, or about 90, 91, 92, 93, 94, 95, 96, 97, 98 or 99% v/v).

The non-metal-doped barium titanate of the present invention may be advantageously in the form of a nano-composite material. The nano-composite may comprise or contain two, three, four or more distinct phases, whereby at least one phase has nanoscale dimensions. In some preferred embodiments, the non-metal-doped barium titanate nano-composite comprises a mixture of cubic and tetragonal phases. In such arrangements, the tetragonal phase may be in the form of inclusions which are embedded in the cubic phase, although other combinations of phases may also provide the advantages of the present invention. In some preferred embodiments, the tetragonal phase is present in the nano-composite as the dominant phase (that is, present at greater than 50 vol % if the non-metal-doped barium titanate).

As the skilled person would appreciate, a photocatalyst (such as the BTO-based catalyst of the present disclosure) is activated by actinic radiation such as visible and/or UV light. In the case of the BTO-based photocatalyst of the present disclosure, the substance that the catalyst acts on is water. Therefore, in any method of using the catalyst described herein, water and light must be present.

Advantageously, the water that is used with the catalyst of the present disclosure for the generation of hydrogen gas may be from a wide range of water sources. As the skilled person would appreciate, many (if not all) known water splitting catalysts are sensitive to dissolved ions (such as chloride, sodium, potassium, magnesium and the like), with only deionized water suitable for use with these known catalysts. However, as discussed herein, the catalyst of the present disclosure advantageously can be used with water that is not deionized. It may be used with water obtained from natural water sources, such as seawater, brackish ground water or estuarine water, riverine water or lake water, or it may be used with water from man-made sources, such as industrial waste water. In one particularly preferred embodiment, the water source is seawater or brackish water.

As the skilled person would appreciate, the BTO-based photocatalyst of the present disclosure is also piezoelectric. It would also be appreciated by the skilled person that the combination of photocatalytic and piezoelectric properties in the same material may be synergistic, in that the activity of a photo/piezocatalyst is greatest when exposed to both actinic radiation and mechanical force. Without being bound to theory, the inventors understand that, at least in the BTO-based material described herein, this effect is due to a phenomenon known as “bend bending”, whereby the energies represented by the edges of the CB and/or VB can be engineered to deviate from their fixed energies, thereby effectively shifting these energies. In doing so, the band gap can be altered. The energy bands may be lowered by the same magnitude, or they may be lowered at different magnitudes. It follows that, if the energy bands are lowered by different magnitudes, the band gap will also be altered. As the skilled person would appreciate, in order to activate the piezoelectric effect, the mechanical force may be provided by any suitable means. For example, the piezoelectric effect may be permanently or continuously activated under static conditions, such as via the application of a mechanical load, or it may be activated under dynamic conditions, such as via the application of vibrations. In one preferred embodiment, the mechanical force is provided by vibrations. The vibrations may be provided by any suitable source, such as an ultrasonicator, or they may be provided by a source of waste energy, such as a motor or a dynamo that provides a consistent, or substantially consistent, source of vibrational energy, or they may be provided by a renewable environmental source, such as by harnessing wave action. The vibrations may be provided by any suitable source. In one preferred embodiment, the vibrations are provided by an ultrasonicator. The power of the ultrasonicator may be operated at a power of greater than about 300 W, for instance it may be between about 300 W and 600 W, or between about 350 W and 550 W, or between about 400 W and 500 W, such as about 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600 W or higher, or any range therein. The frequency of the vibrations that are applied to the catalyst may be between about 10 and about 500 Hz, such as between about 10 and 50 Hz, or between about 50 and 100 Hz, or between 100 and 200 Hz, or between 200 and 500 Hz, for example it may be 10, 15, 20, 25, 30, 35, 40, 45, 50, 60, 70, 80, 90, 100, 110, 120, 130, 140, 150, 160, 170, 180, 19, 200, 220, 240, 260, 280, 300, 320, 340, 360, 380, 400, 420, 440, 460, 480 or 500 Hz or any range therein. In one embodiment, the frequency of the vibrations may be about 40 Hz.

Accordingly, in some embodiments, the non-metal-doped barium titanate of the present invention is subjected (in step (b) of the first aspect) to actinic radiation and mechanical force, either sequentially, substantially sequentially, simultaneously or substantially simultaneously.

In a second aspect of the present invention, there is provided a process for producing a non-metal-doped barium titanate, wherein the process comprises the steps of:
(i) providing non-metal-doped white barium titanate,
   wherein the non-metal-doped white barium titanate comprises Ti⁴⁺, and
   wherein greater than 90 wt % of the non-metal-doped white barium titanate is in the cubic phase and
   wherein the non-metal-doped white barium titanate obtained in step (i) has a
   white colour such that the L* value is in the range of from 70 to 99; and
(ii) contacting the non-metal-doped white barium titanate from step (a) with hydrogen gas, wherein step (ii) is carried out at a temperature (t) in the range of from 600° C. to 1100° C., a hydrogen concentration (c) in the range 3.0 v/v % to 100 v/v %, and for a duration (d) in the range 1.0 hr to 15 hours,
to form non-metal-doped barium titanate wherein the non-metal-doped barium titanate has a grey colour such that the L* value is in the range of from 5.0 to 70 and the b* value is greater than −5.0,
wherein the non-metal-doped barium titanate has a molar ratio of Ti⁴⁺:Ti^{<4+} of from 5.0:1 to 15:1,
wherein the non-metal-doped barium titanate is in the form of a nano composite,
wherein the nano-composite comprises a mixture of cubic and tetragonal phases, wherein the tetragonal phase is in the form of inclusions which are embedded in the cubic phase, and
wherein greater than 50 wt % of the nano-composite is in the tetragonal phase.

In the process of the second aspect, the hydrogen concentration (c) is preferably below the flammability limit. As discussed in more detail below, it is an advantage of the present invention that relatively low concentrations of hydrogen gas can be used to reduce the non-metal-doped barium titanate, leading to a process with improved safety as the risk of explosion is decreased.

Notably, the process of the second aspect comprises annealing the catalyst in a hydrogen gas atmosphere. As the skilled person would appreciate, annealing generally includes the steps of controlled heating of a material from room temperature, maintaining an elevated temperature for a period of time, before then cooling the material. In an embodiment of the present disclosure, the annealing includes heating particles comprising or containing BTO to a temperature of about 800° C., such as between about 600° C. and about 1100° C., or between about 700° C. and about 900° C., or between about 750° C. and 850° C., for example about 600, 625, 650, 675, 70, 725, 750, 775, 800, 825, 850, 875, 900, 925, 950, 975, 1000, 1025, 1050, 1075 or 1100° C. Once heated, the material is held at the elevated temperature for between about 1 hour and about 15 hours, such as between about 1 and 10 hours, or between about 5 and 15 hours, or between about 8 and 12 hours, or between about 10 hours and 14 hours, or between about 11 hours and about 13 hours, for example about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5 or 16 hours.

The method of the present aspect may optionally comprise the further step of adding a hole scavenger to the water before exposing the catalyst to light and/or vibrations. As the skilled person would appreciate, the addition of a hole scavenger has the effect of preferentially reacting with holes at the anode to change the product that is obtained. For example, if methanol is present, it will react at the anode to produce carbon dioxide, instead of allowing the water to react to form oxygen gas. Suitable hole scavengers include alcohols (such as primary alcohols, for example methanol, ethanol, propanol, butanol, pentanol, cyclobutanol, cyclopentanol, cyclohexanol, phenol, benzyl alcohol and the like; secondary alcohols, for example 2-propanol, 2-butanol, 2-pentanol, 3-pentanol, 1-phenylethanol, 1-cyclobutyethanol, 1-cyclopentyethanol and the like; and tertiary alcohols, for example 2-methylpropan-2-ol, 2-methylbutan-2-ol, 2-methylpentan-2-ol, 3-methylpentan-3-ol, 2-cyclobutyl-2-propanol, 2-cyclopentyl-2-propanol, 2-phenyl-2-propanol and the like), organic acids (such as lactic acid, acetic acid, formic acid, citric acid, oxalic acid, uric acid, malic acid, tartaric acid and the like) and tertiary amines (such as trimethanolamine, triethanolamine and the like). As the skilled person would be aware, methanol, ethanol, lactic acid and triethanolamine are particularly suitable hole scavengers.

In a fourth aspect of the present disclosure, there is provided a non-metal-doped barium titanate, wherein the non-metal-doped barium titanate has a molar ratio of Ti⁴⁺:Ti^{<4+} of from 5.0:1 to 15:1, wherein the non-metal-doped barium titanate is in the form of a nano-composite, wherein the nano-composite comprises a mixture of cubic and tetragonal phases, wherein the tetragonal phase is in the form of inclusions which are embedded in the cubic phase, and wherein greater than 50 wt % of the nano-composite is in the tetragonal phase.

In some embodiments, the non-metal-doped barium titanate has a band gap equal to or less than 3.0 eV and a fermi level of from 0.35 to 0. In some preferred embodiments, the non-metal-doped barium titanate has a grey colour such that the L* value is from 5.0 to 70 and the b* value is greater than −5.0.

In a fifth aspect of the present invention, there is provided a piezo photocatalytic process for the production of hydrogen from water according to the first aspect,
wherein the non-metal-doped barium titanate provided in step (a) is obtained by a process according to the second aspect, and
wherein the non-metal-doped barium titanate provided in step (a) is a non-metal-doped barium titanate according to the third aspect.

### ASPECTS OF THE DISCLOSURE

1. A BTO-based photocatalyst, wherein the catalyst is piezoelectric and has a band gap of less than 3 eV.

2. The photocatalyst of aspect 1, wherein the band gap is defined by a CB that is greater than 0 eV and a VB that is less than 1.23 eV.

3. The photocatalyst of aspect 2, wherein the CB is about −0.91 eV and the VB is about 2.05 eV.

4. The photocatalyst of any one of aspects 1 to 3, wherein the photocatalyst includes at least one defect.

5. The photocatalyst of aspect 4, wherein the at least one defect is an oxygen vacancy and/or a reduced Ti ion, or a combination thereof.

6. The photocatalyst of aspect 5, wherein the oxygen vacancy and/or reduced Ti ion are introduced by exposing BTO-based particles to a reducing atmosphere.

7. The photocatalyst of aspect 5 or 6, wherein the reduced Ti ion is Ti(III) or Ti(II) or Ti(0).

8. The photocatalyst of aspect 7, wherein the atmosphere comprises H₂.

9. The photocatalyst of aspect 8, wherein the atmosphere comprises 5% v/v H₂ and 95% v/v noble gas.

10. The photocatalyst of any one of aspects 1 to 9, wherein the CB and VB band energies are lowered on exposure to mechanical force.

11. The photocatalyst of aspect 10, wherein the mechanical force is provided by vibrations.

12. A method for making the catalyst according to any one of aspects 1 to 11, comprising annealing the catalyst in a hydrogen gas atmosphere.

13. The method of aspect 12, wherein annealing is carried out at about 800 degrees C. for about 12 hours.

14. A method of producing hydrogen gas, comprising the step of exposing the catalyst of any one of aspects 1 to 11 to water and light.

15. The method of aspect 14, wherein the catalyst is also exposed to vibrations.

16. The method of aspect 14 or 15, wherein the water is obtained from a natural water source.

17. The method of aspect 16, wherein the natural water source is seawater or brackish water.

18. The method of any one of aspects 14 to 17, wherein the light is solar radiation less than about 400 nm.

19. The method of aspect 15, wherein the vibrations are provided by an ultrasonicator at a power of greater than 300 W.

20. The method of any one of aspects 14 to 19, further comprising the step of adding a hole scavenger such that the hydrogen obtained is pure or substantially pure.

21. The method of aspect 20, wherein the oxygen scavenger is an alcohol or an organic acid.

22. Use of the photocatalyst of any one of aspects 1 to 11 for producing hydrogen gas by splitting water, wherein the catalyst is exposed to water, light and vibration.

23. The use of aspect 21 or 22, wherein the water is seawater or brackish water.

In some aspects, the present invention provides a piezo photocatalytic process for the production of hydrogen from water, wherein the process comprises the steps of:
(a) obtaining non-metal-doped grey barium titanate,
wherein the non-metal-doped grey barium titanate has a molar ratio of Ti⁴⁺: Ti^{<4+} of from 5.0:1 to 15:1 at the surface,
wherein the non-metal-doped grey barium titanate is in the form of a nano composite,
wherein the nano-composite comprises a mixture of cubic and tetragonal phases, wherein the tetragonal phase is embedded in the cubic matrix as inclusions, and
wherein greater than 50 wt % of the nano-composite is in the tetragonal phase;
(b) contacting the non-metal-doped grey barium titanate obtained in step (a) with water to form a reaction mixture; and
(c) subjecting the reaction mixture formed in step (b) to:
(i) actinic radiation; and
(ii) mechanical force,
to produce hydrogen from the water.

In some aspects, the mechanical force is generated by the application of vibrations, especially ultrasound vibrations.

In some aspects, the present invention also provides a process for producing non-metal-doped grey barium titanate, wherein the process comprises the steps of:
(i) obtaining non-metal-doped white barium titanate,
wherein the non-metal-doped white barium titanate comprises Ti⁴⁺,
wherein greater than 90 wt % of the barium titanate is in the cubic phase; and
(ii) contacting the non-metal-doped white barium titanate from step (a) with hydrogen gas,
wherein step (ii) is carried out at a temperature (t), hydrogen concentration (c) and duration (d) such that the product of (c) multiplied by (t) multiplied by (d) is within the below defined range t*d*c=from 400 to 2500
wherein the temperature (t) is in the range of from 600° C. to 1100° C.
wherein the hydrogen concentration (c) is in the range of from 3.0 v/v % to 100 v/v %, and
wherein the duration (d) is in the range 1.0 hr to 15 hours,
to form non-metal-doped grey barium titanate,
wherein the non-metal-doped grey barium titanate has a molar ratio of Ti⁴⁺:Ti^{<4+} of from 5.0:1 to 15:1,
wherein the non-metal-doped grey barium titanate is in the form of a nano composite,
wherein the nano-composite comprises a mixture of cubic and tetragonal phases,
wherein the tetragonal phase is embedded in the cubic phase as inclusions, and
wherein greater than 50 wt % of the nano composite is in the tetragonal phase.

In some aspects, the present invention also provides a non-metal-doped grey barium titanate,
wherein the non-metal-doped grey barium titanate has a molar ratio of Ti⁴⁺:Ti^{<4+} of from 5.0:1 to 15:1,
wherein the non-metal-doped grey barium titanate is in the form of a nano composite,
wherein the nano-composite comprises a cubic and tetragonal phases, wherein the tetragonal phase is embedded in the cubic phase as inclusions, and wherein greater than 50 wt % of the nano-composite is in the tetragonal phase.

Without wishing to be bound by theory, it is believed that this structure of barium titanate nano-composite enhances the stability of the material.

### Definitions

The following definitions are provided to enable the skilled person to better understand the disclosure disclosed herein. These are intended to be general and are not intended to limit the scope of the disclosure to these terms or definitions alone. Unless defined otherwise, all technical and scientific terms used herein have the same meaning as commonly understood by one having ordinary skill in the art to which the disclosure pertains.

As used herein, the term “comprising” means “including”. Variations of the word “comprising”, such as “comprise” and “comprises”, have correspondingly varied meanings. As used herein, the terms “including” and “comprising” are non-exclusive. As used herein, the terms “including” and “comprising” do not imply that the specified integer(s) represent a major part of the whole.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, process or method that includes materials, steps, features, components, or elements, in addition to those literally disclosed, provided that these additional materials, steps, features, components, or elements do not materially affect the basic and novel characteristic(s) of the present disclosure. The term “consisting essentially of” occupies a middle ground between “comprising” and “consisting of”.

Where applicants have defined an disclosure or a portion thereof with an open-ended term such as “comprising”, it should be readily understood that (unless otherwise stated) the description should be interpreted to also describe such an disclosure using the terms “consisting essentially of” or “consisting of.” In other words, with respect to the terms “comprising”, “consisting of”, and “consisting essentially of”, where one of these three terms are used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be non-restrictive regarding the number of instances (i.e., occurrences) of the element or component. Therefore “a” or “an” should be read to include one or at least one, and the singular word form of the element or component also includes the plural unless the number is obviously meant to be singular.

Other than in the operating examples, or where otherwise indicated, all numbers expressing quantities of ingredients or reaction conditions used herein are to be understood as modified in all instances by the term “about”. The examples are not intended to limit the scope of the disclosure. In what follows, or where otherwise indicated, “%” will mean “weight %”, “ratio” will mean “weight ratio” and “parts” will mean “weight parts”.

The terms “predominantly” and “substantially” as used herein shall mean comprising more than 50% by weight, unless otherwise indicated.

As used herein, with reference to numbers in a range of numerals, the terms “about”, “approximately” and “substantially” are understood to refer to the range of −10% to +10% of the referenced number, preferably −5% to +5% of the referenced number, more preferably −1% to +1% of the referenced number, most preferably −0.1% to +0.1% of the referenced number. Moreover, with reference to numerical ranges, these terms should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, from 8 to 10, and so forth.

As used herein, % v/v refers to the volume of a particular gaseous component relative to total volume of the referenced gas.

The complete disclosures of the patents, patent documents and publications cited herein are incorporated by reference in their entirety as if each were individually incorporated.

### Abbreviations

The following abbreviations are used herein:
AFM—atomic force microscopy
BTO—barium titanate (BaTiO₃)
BQ—P-benzoquinone
CB—conduction band
CPD—contact potential difference
EDS—energy-dispersive X-ray spectroscopy
EPR—electron paramagnetic resonance
HER—hydrogen evolution reaction
HRTEM—high resolution transmission electron microscopy
IPA—isopropyl alcohol
MB—Methylene Blue
MO—methyl orange
OER—oxygen evolution reaction
PFM—piezo-response force microscopy
PL—photoluminescence spectroscopy
RhB—Rhodamine B
ROS—reactive oxygen species
SEM—scanning electron microscope
TEOA—triethanolamine
UPS—Ultraviolet photoelectron spectroscopy
UV—ultraviolet
VB—valence band
VBM—Valence band model
XPS—X-ray photoelectron spectroscopy
XRD—X-ray diffraction

### BRIEF DESCRIPTION OF DRAWINGS

FIG. 1—Characterisation of defective BTO nanoparticles: XRD patterns of BTO-O, BTO-N, BTO-A and BTO-H samples at (a) range 10°-100° 2θ (identical pattern scales) and (b) range 30°-35° 2θ (identical pattern scales); and (c) laser Raman microspectroscopy patterns (identical pattern scales).

FIG. 2: XRD Rietveld refinement data for cubic and tetragonal BTO-H.

FIG. 3—HRTEM images of BTO-H: at (a) low-magnification, (b) high-magnification, and (c) SAED image for BTO-H for (b)

FIG. 4—SEM, TEM, and EDS images of defective BTO nanoparticles: (a) BTO-O, (b) BTO-N, (c) BTO-A, (d) BTO-H.

FIG. 5—Defect analysis: (a) Room-temperature EPR spectra of BTO-H and (b) high-temperature (70° C.) EPR spectra of BTO-H.

FIG. 6—XPS spectra: (a) O 1s (subsurface) and (b) Ti 2p (surface).

FIG. 7—Defect analysis: PL spectra (identical pattern scales).

FIG. 8—KPFM imaging: a) Topography of BTO-H drop-cast film (b) contact potential difference (CPD) of BTO-H drop-cast film.

FIG. 9—Bandgap analysis: Resultant energy band diagrams (pH=7).

FIG. 10—Corresponding piezo-response force microscopy (PFM) images of defective BTO-H nanoparticles: Amplitude and hysteresis loop.

FIG. 11—Organic photocatalysis: Photo-degradation of RhB as a function of time when in contact with the BTO-based photocatalyst.

FIG. 12—Hydrogen generation over time: (a) test data and (b) test rates for hydrogen generation using BTO-H, BTO-A, BTO-O and BTO-N exposed to 2 hours of UV light and then 3 hours of combined UV light and sonication.

FIG. 13—Hydrogen generation in differing water sources: (a) test data and (b) test rates for hydrogen generation by BTO-H in deionized water, simulated seawater and collected seawater.

FIG. 14—Hydrogen generation catalyst activation methods: (a) test data and (b) test rates for different BTO-H catalyst activation methods (light only, sonication only, sequential sonication then light, and simultaneous sonication and light).

FIG. 15—Oxygen generation: Ratios of O₂/N₂ in mixed gas samples obtained from BTO-H catalysis of water, as measured by gas chromatography under different test conditions.

FIG. 16—Hydrogen generation sonication power: (a) test data and (b) test rates for different piezocatalysis power levels (sonication only) for BTO-H catalyst.

### DESCRIPTION OF EMBODIMENTS

The following description conveys exemplary embodiments of the present disclosure in sufficient detail to enable those of ordinary skill in the art to practice the present disclosure. Features or limitations of the various embodiments described do not necessarily limit other embodiments of the present disclosure or the present disclosure as a whole. Hence, the following detailed description does not limit the scope of the present disclosure, which is defined only by the claims.

The present disclosure relates to an improved catalyst for the catalysed photolysis of water, as well as a method for producing the catalyst and the use of the catalyst.

In particular, the inventors have developed a catalyst that is capable of efficiently producing hydrogen gas from non-pure water sources. As will be described in more detail below and with reference to the examples, the catalyst of the present disclosure is a photocatalyst (i.e., produces hydrogen gas by splitting water when illuminated by a light source, preferably solar light) and is also piezoelectric (i.e., produces electrical energy in response to vibrations or mechanical energy). Advantageously, the inventors have found that the piezoelectric properties and photocatalytic properties act in concert to alter the band structure of the catalyst (such as reducing the band gap and bringing the conduction and valence bands closer to the potentials of the reactions occurring at the of the anode and cathode respectively) when exposed to mechanical energy, thereby allowing more of the visible portion of the electromagnetic spectrum to be suitable to activate the photocatalyst and a reduction in the overpotential required to split water and product hydrogen gas. It has also been advantageously found that the products produced by the catalyst of the present disclosure may be tuned by the conditions that the catalyst is exposed to.

### Catalyst

The catalyst of the present disclosure comprises, or consists of, or essentially consists of, BTO, a covalent network solid of chemical formula BaTiO₃ (also known as barium titanate), whereby the barium is present as Ba²⁺ cations and the titanium is present as Ti⁺⁴ cations. The BTO-based catalyst of the present disclosure is used to catalyse water splitting reactions so that hydrogen gas is produced.

As the skilled person would appreciate, BTO is considered to be a typical wide-bandgap ferroelectric semi-conducting crystalline solid material with a bandgap of between about 3.2 to about 3.5 eV. As a solid, BTO exists in a range of temperature-dependent crystalline forms, including cubic, tetragonal, orthorhombic and rhombohedral geometries. Certain polymorphic forms of BTO (primarily the tetragonal) are known to have piezoelectric properties and have been used in a range of devices including microphones and other transducers. As a semi-conducting solid, BTO has also previously been investigated for its photocatalytic properties due to its ability to absorb light or other electromagnetic radiation. However its use as a photocatalyst has been limited by the wide-bandgap that is typical of BTO materials. Further, the electro-chemical and electro-physical properties of materials such as barium titanate can be changed by the crystalline structure(s) and surface morphology even when the overall chemical composition remains mostly unchanged. The detailed understanding of these changes is highly complex.

As shown in the examples and as further described below, the inventors of the present disclosure have developed a BTO-based catalyst, specifically a non-metal-doped BTO-based catalyst. By “non-metal-doped”, it is meant herein that the barium titanate of the present invention is not doped with metal atoms (i.e., it is pure or substantially pure barium titanate), but instead may include other defects (such as oxygen vacancies or reduced intrinsic metal ions) as described herein, which may have a “dopant”-like effect. Notably, “non-metal-doped” as used herein is not intended to refer to doping with a non-metal, such as boron, carbon or nitrogen, for example. In particular, the inventors have developed a BTO-based photocatalyst with a narrower bandgap and band energies that are more suitable for catalysing water splitting reactions and/or organic compound radical degradation, when exposed to light or other actinic radiation, which has been achieved by the introduction of certain defects into the BTO crystal structure. Surprisingly, this catalyst is capable of carrying out water splitting reactions in a variety of water sources, including natural seawater. As the skilled person would appreciate, seawater typically contains a variety of ions and dissolved/suspended materials. Typically, the ions are predominantly Na⁺, Cl⁻, Mg²⁺ and K⁺ with varying (but much lower) levels of other ions depending on location. Unpurified water sources, including sea water, will contain organic materials and microorganisms. Typically, the sea water comprises from 10,000 mg/L to 30,000 ml/L, or from 15,000 ml/L to 25,000 mg/Lm or from 17,000 mg/L to 20,000 mg/L Cl ions, which can negatively interact with catalytic processes. It has also been surprisingly shown by the inventors that the exposure of the catalyst to vibrational energy also has an effect on the bandgap and associated energy levels, providing a water-splitting catalyst with good efficiency. The products, particularly at the anode, of the BTO-based catalyst are also tuneable, depending on the conditions under which it is used.

The BTO-based catalyst of the present disclosure may be in any suitable physical form. In one embodiment of the present disclosure, the BTO-based catalyst may be in the form of solid nanoparticles. The nanoparticles may spherical (or substantially spherical) nanoparticles, or they may be cubic (or substantially cubic) nanoparticles, or they may be irregularly-shaped nanoparticles. In one embodiment, the BTO-catalyst may be cubic, or substantially cubic, nanoparticles. They may have any suitable cross-section, such as circular, triangular, cubic, rhomboid, or any other shape. The size of each of the nanoparticles may be on the nanoscale, for instance each of the nanoparticles may have a diameter of between about 1 nm and 999 nm. The nanoparticles, when present as a plurality, may have an average size of between 1 nm and 999 nm, or between about 100 nm and about 900 nm, or between about 150 nm and about 800 nm, or between about 200 nm and about 700 nm, or between about 250 nm and about 750 nm, or between about 300 nm and about 600 nm, or they may have an average diameter of about 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 90, 95, 100, 105, 110, 115, 120, 125, 130, 135, 140, 145, 150, 155, 160, 165, 170, 175, 180, 185, 190, 195, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 995 or 999 nm, or any range therein. The distribution of the size of each of the nanoparticles may follow a normal distribution around the average diameter, or it may approximate a normal distribution. The distribution may be narrow, whereby two standard deviations from the mean encompasses a variation of about 10 nm, or about 20 nm, or about 50 nm, or about 10% of the average size, or about 20% of the average size, or the distribution may be broad, whereby two standard deviations from the mean encompasses a variation of about 200 nm, or about 250 nm, or about 300 nm, or about 400 nm, or about 50% of the average size, or about 75% of the average size, or about 100% of the average size. For example, if the average diameter of the nanoparticles was 450 nm, a narrow distribution would be defined as two standard deviations encompassing the range of between about 400 nm and about 500 nm (i.e., +/−50 nm, or about 11%), or a broad distribution would be defined as two standard deviations encompassing the range of between about 200 nm and about 700 nm (i.e., +/−250 nm, or about 62%). In a preferred embodiment, the average diameter of the nanospheres is between about 10 nm and about 250 nm, or optionally each of the nanoparticles is between about 10 nm and about 250 nm in diameter. In a particularly preferred embodiment, the nanoparticles may be between 30 nm and 50 nm.

Notably, the inventors have observed that not all reduced barium titanates are suitable for the enhanced production of hydrogen by water splitting. As the skilled person would appreciate, there is a form of reduced barium titanate which has a blue colour and is referred to in the literature as “blue barium titanate”. The precise reasons for the blue colour are unclear and beyond the scope of the present application. Without wishing to be bound by theory, it is believed to be a surface interference effect caused by selective etching during certain reduction process of at least some of the intercalated layers forming the barium titanate. Other colours of barium titanate are not reported. For reasons that are still somewhat unclear due to the complexities of the possible interactions, blue barium titanate has been observed to exhibit differences compared to white/grey/black barium titanate under the influence of mechanical force and radiation that make it very non-preferred for enhanced hydrogen production processes. Hence non-preferred reduced barium titanate for use in hydrogen production processes can be identified by colour, specifically using the L*a*b* colour scale where blue colours are identified by lower negative b* values, such as <−5. Typically, the non-metal-doped barium titanate has a colour such that the L* value is from 0.0 to 80 and the b* value is greater than −5.0. More preferred L* ranges are between 40 and 75 or even 50 to 70. Preferred b* values are between −5.0 and +10, such as >−4.0 or −3.0 or 0 or +1 or +2 or +5.

As mentioned above, the advantageous effects observed for the BTO-based photocatalyst of the present disclosure are understood to be due to the presence of certain defects that are introduced into the crystal structure, which are discussed in more detail below, including a method for introducing such defects into the BTO structure.

### Photolysis

As the skilled person would appreciate, catalysed photolysis refers to a process whereby actinic radiation (such as wavelengths of light) is absorbed by a substrate, which leads to the breaking of a covalent bond and hence a chemical reaction. By “actinic radiation”, it refers to electromagnetic radiation that can produce photochemical reactions. In some embodiments, the actinic radiation is ultra-violet radiation. In the case of the present disclosure, the substrate is in the form of a BTO-based catalyst, and the reaction includes splitting water to produce hydrogen gas and an oxygen-containing species. The oxygen-containing species may be oxygen gas (i.e., O₂) or it may be a hydroxyl ion (i.e., OH⁻) or it may be a hydroxyl radical (⋅OH) or it may be a superoxide radical (⋅O₂⁻) or it may be any combination thereof. As the skilled person will appreciate, the oxygen species that is produced with be dependent on the conditions that the catalyst is exposed to (that is, light wavelength(s), light intensity, water quality (including concentration and identity of dissolved species), vibrational frequency, vibrational power, and the like).

In particular, the catalyst of the present disclosure is a semiconductor. Unlike materials such as metals, which have a continuum of energy states, semiconductors have defined energy states, which includes an energy ‘void’ region which extends from the top of the filled valence band (VB) (i.e., the highest occupied electron state) to the bottom of the vacant conduction band (CB) (i.e., the lowest unoccupied electron state). This void region is referred to as the “bandgap” and is calculated as the difference between the CB and VB energies. It is understood that a semiconductor catalyses photolysis by absorbing a photon that is at least, if not more, energetic than the bandgap of the semiconductor material. This energy promotes an electron into the conduction band and leaves a positive hole in the valence band. The larger the bandgap, the less likely it is for the electron and the hole to recombine and release the energy as heat, although this recombination in the bulk of the material competes with the diffusion of the electrons and the holes to the surface, whereby both the excited electron and the positive hole can be used to drive reactions; the reduction reaction being mediated by the excited electron, and the oxidation reaction is mediated by the positive hole. However, larger bandgaps also require higher energy photons in order to promote an electron from the valence band to the conduction band, meaning that there is a trade-off in photocatalyst design between the frequency of absorbable light, and the magnitude of the bandgap capable of doing catalytic work.

In the catalysed photolysis of water, as preferred by the present disclosure, the steps required to split water are: (1) light is absorbed by the photocatalyst; (2) an electron is excited from the valence band to the conduction band, simultaneously producing a positive hole in the valence band; (3) the recombination of the excited electrons and holes compete with the diffusion of these charge carriers to the surface, where they can participate in reactions; (4) when an excited electron does diffuse to the surface, it can participate in a reduction reaction, such as the HER (4H⁺+4e⁻→2H₂) and when a hole does diffuse to the surface, it can participate in an oxidation reaction, such as the OER (2H₂O+4h⁺→O₂+4H⁺). However, the precise reduction and oxidation reactions that occur depend on the energies of the valence and conductive bands, and the reactants in contact with the photocatalyst. For instance, in order for a catalyst to split water according to the reactions provided above, the band gap must be at least 1.23 eV, whereby the valence band must be at least 1.23 eV (or higher, i.e., more positive), and the conduction band should be at least 0 eV (or lower, i.e., more negative), which are the potentials required to drive each of these half-reactions. If a material has a band gap that is less than 1.23 eV, or the VB is less than 1.23 eV, or the CB is greater than 0 eV, then the material will be unable to split water, at least via the OER and HER pathways discussed above. On the other hand, if the CB is significantly in excess of the minimum voltage requirements to drive a reaction (e.g., more than about 0.5 eV in excess), the energy used to promote each electron into the conduction band will be essentially wasted as heat, significantly reducing the efficiency of the catalyst by introducing an overpotential. As the skilled person would appreciate, it is essential for the CB to be above the HER potential in order to produce hydrogen gas. However, the VB may be below the OER potential in order to produce oxygen gas from water, or it may produce another species, such as OH. That being said, the skilled person will also appreciate that there will be some compromise between the location of the band edges relative to the HER and OER potentials and the overall size of the band gap. For example, if the band gap is too large, this may negatively affect the efficiency of the catalyst, or if the CB and HER potential are too close together, this may negatively affect the recombination time (i.e., the time taken for electrons and holes to recombine and annihilate each other) and hence efficiency of the catalyst.

The skilled person will also appreciate that the bandgap of a semiconductor material can be altered or manipulated in a variety of ways. For example, the band energies and associated bandgap may be altered (i.e., decreased or increased) by changing geometry (for example, by changing a BTO material from a tetragonal geometry to an orthorhombic geometry), introducing defects, or altering the polarisation of the catalyst material. However, the effects of each of these changes on the catalytic behaviour of the BTO material are not predictable, nor are the effects of carrying our more than one of these changes.

In this regard, the inventors have surprisingly found that the introduction of certain defects into a BTO-based crystal structure results in a catalyst with band energies and a bandgap that are favourable for splitting water when used as a photocatalyst. The defect may be a vacancy in the crystal structure (that is, an ion missing from the regular crystal pattern). It may be an oxygen vacancy (that is, at least one of the oxygen ions are missing from the crystal structure). The defect may be the in situ reduction of a metal ion. It may be the reduction of at least one of the Ti⁴⁺ ions to a reduced state, such as a Ti³⁺ ion, or a Ti²⁺ ion, or a Ti atom. As the skilled person would appreciate, a point change in the crystal ionic radii from a Ti⁴⁺ ion (74.5 pm) to a Ti³⁺ ion (81 pm) or a Ti²⁺ ion (100 pm) would introduce significant local strain on the crystal structure of the catalyst. In some embodiments, the defect may be the substitution of a barium or titanium ion with another metal ion, such as Na⁺, K⁺, Ca²⁺, Mg²⁺, Zr³⁺, Fe³⁺, Mn⁴⁺, for example. The defect may be any combination of these defects. The defect, or defects, may result in the distortion of the crystal geometry, or the co-existence of two or more polymorphic forms in the same crystal. For example, the BTO-based catalyst may comprise both cubic and tetragonal geometries, or cubic and orthorhombic geometries, or cubic and rhombohedral geometries, or tetragonal and orthorhombic geometries, or tetragonal and rhombohedral geometries, or orthorhombic and rhombohedral geometries, or cubic, tetragonal and orthorhombic geometries, or cubic, orthorhombic and rhombohedral geometries, or tetragonal, orthorhombic and rhombohedral geometries. In one preferred embodiment of the present disclosure, the BTO-based catalyst comprises both cubic and tetragonal geometries. In one particularly preferred embodiment of the present disclosure, the BTO-based catalyst comprises oxygen vacancies, Ti³⁺ ions and/or Ti²⁺ ions and/or Ti atoms, and both cubic and tetragonal geometries.

In view of the above, the photocatalyst of the present disclosure, comprising at least one type of defect and being suitable for the catalytic photolysis of water, preferably has a band gap greater than 1.23 eV, but less than 3.2 eV, preferably less than 3.1 eV, even more preferably below 3.0 eV. The band gap may be between 3.2 eV and 1.23 eV, for instance it may be between about 3 eV and about 1.8 eV, or between about 2.95 eV and about 2 eV, or between about 2.9 eV and about 2.2 eV, or it may be about 3.2, 3.19, 3.18, 3.17, 3.16, 3.15, 3.14, 3.13, 3.12, 3.11, 3.10, 3.09, 3.08, 3.07, 3.06, 3.05, 3.04, 3.03, 3.02, 3.01, 3.00, 2.99. 2.98. 2.97, 2.96, 2.95, 2.94, 2.93, 2.92, 2.91, 2.90, 2.89, 2.88, 2.87, 2.86, 2.85, 2.84, 2.83, 2.82, 2.81, 2.80, 2.79, 2.78, 2.77, 2.76, 2.75, 2.74, 2.73, 2.72, 2.71, 2.70, 2.69, 2.68, 2.67, 2.66, 2.65, 2.64, 2.63, 2.62, 2.61, 2.60, 2.58, 2.56, 2.54, 2.52, 2.50, 2.45, 2.40, 2.35, 2.30, 2.25, 2.20, 2.15, 2.10, 2.05, 2.00, 1.95, 1.90, 1.85, 1.80, 1.75, 1.70, 1.65, 1.60, 1.55, 1.50, 1.45, 1.40, 1.38, 1.36, 1.34, 1.32, 1.30, 1.29, 1.28, 1.27, 1.26, 1.25, 1.24, 1.23, or any range therein. To provide a band gap between about 3.2 eV and 1.23 eV, the catalyst may have a CB that is equal to, or may substantially align with, or may be more negative than, the potential required by the HER, which is about 0 eV, and a VB that is equal to, or may substantially align with, or may be more positive than, the potential required by the OER, which is about 1.23 eV. By “substantially align”, it is meant that the variation from the minimum CB or VB values may be no more than about 1.0 eV. Accordingly, the catalyst may have a CB less than 0 eV, or between 0 eV and about −1.0 eV, and the VB may be greater than 1.23 eV, or between 1.23 eV and about 2.23 eV. For example, the CB may be between about 0 eV and about −1.0 eV, or between about −0.1 eV and about −0.8 eV, or between about −0.25 eV and about −0.75 eV, or it may be about 0, −0.01, −0.02, −0.03, −0.04, −0.05, −0.06, −0.07, −0.08, −0.09, −0.1, −0.11, −0.12, −0.13, −0.14, −0.15, −0.16, −0.17, −0.18, −0.19, −0.2, −0.21, −0.22, −0.23, −0.24, −0.25, −0.26, −0.27, −0.28, −0.29, −0.3, −0.31, −0.32, −0.33, −0.34, −0.35, −0.36, −0.37, −0.38, −0.39, −0.4, −0.41, −0.42, −0.43, −0.44, −0.45, −0.46, −0.47, −0.48, −0.49, −0.5, −0.51, −0.52, −0.53, −0.54, −0.55, −0.56, −0.57, −0.58, −0.59, −0.60, −0.61, −0.62, −0.63, −0.64, −0.65, −0.66, −0.67, −0.68, −0.69, −0.7, −0.71, −0.72, −0.73, −0.74, −0.75, −0.76, −0.77, −0.78, −0.79, −0.80, −0.81, −0.82, −0.83, −0.84, −0.85, −0.86, −0.87, −0.88, −0.89, −0.90, −0.91, −0.92, −0.93, −0.94, −0.95, −0.96, −0.97, −0.98, −0.99 or −1.0 eV, or any range therein. Likewise, the VB may be between 1.23 eV and about 2.23 eV, or between about 1.30 eV and about 1.90 eV, or between about 1.50 eV and about 1.80 eV, or it may be about 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, 1.51, 1.52, 1.53, 1.54, 1.55, 1.56, 1.57, 1.58, 1.59, 1.60, 1.61, 1.62, 1.63, 1.64, 1.65, 1.66, 1.67, 1.68, 1.69, 1.70, 1.71, 1.72, 1.73, 1.74, 1.75, 1.76, 1.77, 1.78, 1.79, 1.80, 1.81, 1.82, 1.83, 1.84, 1.85, 1.86, 1.87, 1.88, 1.89, 1.90, 1.91, 1.92, 1.93, 1.94, 1.95, 1.96, 1.97, 1.98, 1.99, 2.00, 2.01, 2.02, 2.03, 2.04, 2.05, 2.06, 2.07, 2.08, 2.09, 2.10, 2.11, 2.12, 2.13, 2.14, 2.15, 2.16, 2.17, 2.18, 2.19, 2.20, 2.21, 2.22 or 2.23 eV, or any range therein. In one embodiment, the catalyst of the present disclosure has a band gap or about 2.96 eV, a CB of about −0.91 eV and a VB of about 2.05 eV. However, other particular combinations of band edge locations (VB and CB) and overall band gap energies may be more efficient than others, and it may be possible to optimize the location of the band edges and the band gap in order to split water efficiently or carry out some other catalysed reactions, such as organic degradation reactions. As the band gap for the barium titanate catalyst used in the present invention is typically about 3.0 eV, it is typically capable of absorbing substantially all of the wavelengths of ultraviolent light below about 400 nm (as photons of ultraviolet light with frequencies between about 100 nm and about 400 nm have energies of between about 12.4 eV and 3.15 eV, respectively).

Preferably, the non-metal-doped barium titanate has a fermi level of from 0.35 to 0. The Fermi level provides an indication of the energy level of the charge carrier population (half of the charge carriers are above it and half are below it). The closer the Fermi level is to the HER or OER, the easier it is for that reaction to occur. The Fermi level is part of the band energy so when above mentioned factors change the band gap and/or band edges, the fermi level will be altered as well.

The light source providing the actinic radiation may be any suitable source of photons at a visible wavelength (i.e., between about 400 nm and about 700 nm) and/or at an ultraviolet wavelength (i.e., between about 100 nm and about 400 nm). The light source may be naturally occurring (such as solar energy) or it may be from an artificial source (such as an LED light, an incandescent bulb, or the like).

### Piezoelectric Properties

A process that is being investigated for hydrogen production is piezocatalysis. This process is based on the principal of converting mechanical energy (usually vibrational energy) into chemical energy. Without being bound to theory, in such catalysts it is expected that the piezo-potential that is induced in piezoelectric materials on exposure to vibrations (or other mechanical force) may initiate the catalytic process by altering the band structure (i.e., the bandgap and band energies) and controlling the internal charge carrier flow to the catalyst surface, thereby providing energy at the surface of the catalyst that can be used to initiate the recatalysed reaction. Further, ferroelectric materials with high piezoelectric coefficients may be particularly suitable candidates for use as piezocatalysts.

Further, the skilled person would appreciate that the piezoelectric effect of a piezocatalyst can allow for improved photo-generated carrier separation for improving photocatalytic activity of semiconductor photocatalysts. In other words, a catalyst with piezoelectric effects and photocatalyst activity may be expected to show enhanced catalytic activity when exposed to both light irradiation and mechanical force. Without being bound by theory, it is expected that this occurs by “band bending” in that the piezo-potential polarizes the surfaces of the catalyst, attracting the electrons and holes to the surface and therefore slowing down recombination. The “band bending” may also have the effect of altering the products that are produced by the catalyst, as the CB or VB may “bend” (i.e., become lower) and therefore favour a different half-reaction (and hence produce a different product).

As mentioned above, BTO-based materials may be suitable for use as a piezocatalyst in water splitting and/or organic compound degradation, due to its ferroelectric and piezoelectric properties (when arranged in particular geometries, in particular tetragonal geometries). Without being bound by theory, it is understood that subjecting barium titanate to mechanical force, such as the vibrations provided by ultrasound or ocean waves, generates a charge on the surface which can drive chemical reactions such as water splitting. Changing the structure of tetragonal barium titanate can enhance the piezoelectric properties. The mechanical force may be provided by any suitable means. In one preferred embodiment, the mechanical force is provided by vibrations. The vibrations may be provided by any suitable source, such as a sonicator, or they may be provided by a source of waste energy, such as a motor or a dynamo that provides a consistent, or substantially consistent, source of vibrational energy or they may be provided by natural sources such as wave action. An especially preferred embodiment is for the mechanical force to be applied by ultrasonic vibration. Typically, ultrasound refers to sound frequencies greater than 20 kHz, such as about 25 kHz, about 30 kHz, about 35 kHz, about 40 kHz or more. as the skilled person would appreciate, using pulsed mechnical vibration, such as ultrasound, (i.e. the ultrasound in applied in pulses of specific duration at a defined pulse frequency) may reduce the total energy consumption of the treatment process. Alternatively, applying the actinic radiation in pulses with continuous application of the mechanical vibrations may also reduce the total input energy requirement of the process.

Alternatively, the mechanical force can be applied as a consistent force, such as by compression. In particular, a BTO-based material with certain defects that are introduced via processing steps, may be particularly suited for use as a photo/piezocatalyst.

### Production Method

Raw particles of the BTO-based material may be produced by any standard method known in the art, such as standard hydrothermal techniques, solid-state reactions and sol-gel methods. As mentioned above, the most advantageous form of the catalyst of the present disclosure includes defects, however these defects are advantageously introduced into the BTO-based nanoparticle material by exposing the material to post-processing steps. In other words, any source of nanoparticulate BTO is suitable to produce the catalyst of the present disclosure. The most common method described in the art to modify the properties of barium titanate is to dope it with other metals, such as bismuth. This can be effective and does deliver barium titanate-based materials with improved properties. However, such modifications typically need to be included in the initial synthesis and such steps introduce cost and complexity. It also means that it is not possible to easily leverage the large current barium titanate manufacturing base.

In order to introduce the desired defects into the BTO-based nanoparticles, the inventors have developed a method to produce a non-metal-doped barium titanate in a post-processing step. In this method, an annealing step is carried out on crystallised barium titanate. The annealing step comprises heating the BTO-based nanoparticles to an elevated temperature under a specific atmosphere and maintaining the elevated temperature for a period of time, before cooling to room temperature. The elevated temperature may be between about 400° C. and about 1000° C., or it may be between about 500° C. and about 900° C., or between about 600° C. and about 800° C., or it may be about 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 or 1000° C. In one embodiment, the annealing temperature is about 800° C. The elevated temperature may be reached by heating either the empty furnace, or the furnace comprising the BTO-based material, at a rate of between 1 and 10° C./min, such as between 2 and 8° C./min, or between 3 and 7° C./min, or about 1, 2, 3, 4, 5, 6, 7, 8, 9 or 10° C./min. The elevated temperature may be held for a period of up to 24 hours, such as for example a period of time between 6 hours and 24 hours, or between 8 hours and 20 hours, or between 10 and 15 hours, or between 12 and 18 hours, or between 1 and 4 hours, or between 2 and 6 hours, or about 0.2, 0.4, 0.6, 0.8, 1, 1.5, 2, 2.5, 3, 3.5, 4, 4.5, 5, 6, 7, 8, 9, 10, 11, 12, 13, 14, 15, 16, 17, 18, 19, 20, 21, 22, 23 or 24 hours. In one preferred embodiment, the period of time is about 12 hours. After the BTO-based material is held at an elevated temperature for a period of time, it is allowed to cool under ambient conditions. The atmosphere that the annealing step is carried out under may affect the types and extent of defects that are introduced into the BTO-based nanoparticles. The atmosphere may comprise any suitable gas. The gas may be inert, or it may be reactive. It may comprise an inert noble gas. It may comprise argon, neon, xenon, krypton, helium, neon, nitrogen, oxygen, hydrogen, carbon dioxide, carbon monoxide, nitric oxide, chlorine or any other suitable gas, in any suitable combination. In some embodiments, the annealing atmosphere comprises argon, hydrogen, oxygen or nitrogen, or any combination thereof. In some embodiments, the atmosphere consists of one of argon, nitrogen or oxygen. In other preferred embodiments, the atmosphere may be a reducing atmosphere. It may comprise hydrogen gas or carbon monoxide. As the skilled person would appreciate, due to the highly flammable nature of hydrogen (and carbon monoxide), safely handling flammable mixtures of reducing gases at elevated temperatures and at large industrial scales is difficult and complex. To reduce the risk, the reducing gas may be mixed with a noble gas or an inert gas. Surprisingly, the inventors have discovered that non-flammable mixtures of hydrogen and inert gas (typically with less than 3% to 7 wt % hydrogen depending on the diluent gas) can still be used to suitably reduce the barium titanate. Use of non-flammable reducing gas mixtures makes large-scale production of suitable reduced barium titanate dramatically safer and easier to implement. The typical flammability limits for a number of different hydrogen/other gas mixtures are: 3 vol % for H₂—Ar; 4 vol % for H₂-air; 4 vol % for H₂—O₂; 5 vol % for H₂—N₂; 6 vol % for H₂—He; and 7 vol % for H₂—CO₂. In some embodiments, the atmosphere may consist, or substantially consist, of a mixture of hydrogen gas or carbon monoxide and argon (or another inert or noble gas) in a ratio of between 1:100 and 1:10 (that is, between 1% v/v and 10% v/v). The ratio of hydrogen gas to argon is between about 1:100 and 1:50, or between about 1:50 and 1:10, or between about 1:75 and 1:25, or between about 1:60 and 1:40, or between about 1:40 and 1:20, or about 1:100, 1:95, 1:90, 1:85, 1:80, 1:75, 1:70, 1:65, 1:60, 1:55, 1:50, 1:45, 1:40, 1:35, 1:30, 1:25, 1:20, 1:15 or 1:10 (that is, the percentage amount of hydrogen present compared to the amount of argon may be between 1% v/v and 2% v/v, or between 2% v/v and 10% v/v, or between 1.3% v/v and 4% v/v, or between 1.67% v/v and 2.5% v/v, or between 2.5% v/v and 5% v/v, or about 1, 1.05, 1.1, 1.15, 1.20, 1.25, 1.30, 1.35, 1.40, 1.45, 1.5, 1.6, 1.7, 1.8, 1.9, 2, 2.25, 2.5, 2.75, 3, 4, 5, 6, 7, 8, 9 or 10% v/v). A preferred embodiment of any reducing gas system is that it is not flammable, i.e. the mixture is incapable of supporting combustion in the atmosphere. The content of the flammable gas is typically below its flammability limit. The atmosphere may be provided at a gas flow rate of between about 10 and about 100 cm³/min, or between about 20 and 80 cm³/min, or between about 25 and 75 cm³/min, or between about 40 and 60 cm³/min, or at about 10, 15, 20, 25, 30, 35, 40, 45, 50, 55, 60, 65, 70, 75, 80, 85, 90, 95 or 100 cm³/min. In one preferred embodiment, the BTO-based nanoparticles may be added to a furnace pre-heated to about 800° C. and maintained at this temperature for about 12 hours under an atmosphere of 5% v/v hydrogen gas and 95% argon which is replenished at a gas flow rate of about 50 cm³/min, and then allowed to return to room temperature under ambient conditions.

### Use

The BTO-based photocatalyst of the present disclosure may be used to catalyse reactions. As would be expected of a photocatalyst, the catalyst of the present disclosure is activated by actinic radiation, such as UV light and/or visible light. As discussed in more detail below and with reference to the examples, the BTO-based photocatalyst may catalyse organic degradation reactions, or it may generate hydrogen gas and/or oxygen gas, or it may catalyse both simultaneously.

In one embodiment, the BTO-based catalyst of the present disclosure may be used for degrading organic compounds. The organic compounds may be dissolved in water, or they may be suspended in water. It is understood that the catalyst of the present disclosure is capable of catalysing organic degradation reactions by producing radical oxygen species (ROS) such as superoxide (⋅O₂⁻) and/or hydroxyl radicals (⋅OH) when illuminated by actinic radiation, whereby the ROS then attack and degrade the organic compounds.

In one embodiment, the present disclosure provides a method for degrading organic compounds that are dissolved and/or suspended and/or in contact in water. The method requires that the catalyst of the present disclosure, as described herein, is in contact with water. The catalyst may be partially in contact with the water (e.g., the catalyst may be floating on a surface, or the water may be applied to top surface of a solid catalyst), or the catalyst may be entirely submerged in the water, or a combination of the two arrangements. The water may be obtained from any suitable water source. As the catalyst does not form an electrolysis cell, the water does not require a dissolved electrolyte in order to carry charge between the cathode and the anode. Accordingly, the water may be distilled water or deionized water. However, advantageously, the catalyst of the present disclosure may be used in seawater, or any other water source. The water source may be a natural water source, such as brackish ground water, estuarine water, riverine water, lake water or stormwater, or it may be of man-made origin, such as industrial waste water, cooling tower water, or any other suitable water source. The water source may be used without pre-treatment, or with only minimal treatment, before use. In one embodiment, the catalyst of the present disclosure may be used to clean water by reducing dissolved organic carbon, and/or improving turbidity, and/or reducing particulates in natural waters.

In another embodiment, the BTO-based catalyst of the present disclosure may be used for generating hydrogen gas, and optionally oxygen gas, from water. This method requires that the catalyst of the present disclosure, as described herein, is in contact with water. The catalyst may be partially in contact with the water (e.g., the catalyst may be floating on a surface, or the water may be applied to top surface of a solid catalyst), or the catalyst may be entirely submerged in the water, or a combination of the two arrangements. The water may be obtained from any suitable water source. As the catalyst does not form an electrolysis cell, the water does not require a dissolved electrolyte in order to carry charge between the cathode and the anode. Accordingly, the water may be distilled water or deionized water. However, advantageously, the catalyst of the present disclosure may be used in seawater, or any other natural water source, such as brackish ground water, estuarine water, riverine water or lake water, or any other suitable water source, without pre-treatment, or with only minimal treatment, before use. It is a further advantage of the present disclosure that the catalyst has a band gap of less than about 3 eV, compared to the expected band gap for pristine BTO of about 3.5 eV. The lower band gap is advantageous as it allows visible light to be absorbed for catalyst activation, rather than UV light. It is also an advantage of the present disclosure that the band energies can be “bent” by the use of mechanical force. As discussed above, the catalyst of the present disclosure is not only a photocatalyst but is also piezoelectric. As demonstrated by the inventors in the Examples, the piezopotential of the BTO-based catalyst of the present disclosure exerts an effect known as “band bending”, whereby both the CB and VB energy bands are lowered, which allows the catalyst to access difference redox half reactions, as the potentials of the excited electrons and the holes are altered. In other words, the application of both light and vibrational energy together allows the catalyst to produce different product(s) than if just light, or just vibrational energy, is provided.

In use, the catalyst of the present invention may be subjected substantially simulaneously to: (i) actinic radiation; and (ii) mechanical vibration (i.e., piezophotocatalysis). By substantially simultaneously it is meant that the reaction mix is subjected to both radiation and vibration within about 1 μs. Preferably, the reaction mixture is subjected simulaneously to: (i) actinic radiation; and (ii) mechanical vibration, i.e. the reaction mixture is subjected to the actinic radiation and mechanical vibration at the same time.

With the catalyst at least partially in contact with the water, each of the methods above also requires illumination of the catalyst by a source of actinic radiation, such as a UV and/or visible light source. As would be evident to the skilled person from the discussion above, the BTO-based catalyst of the present disclosure is a photocatalyst, in that it absorbs photons to produce excited electrons and positive holes, both of which can facilitate chemical reactions, such as the HER to produce hydrogen by splitting water. Accordingly, in this method, the catalyst that is in at least partial contact with the water must be arranged so as to be able to absorb photons from the light source. The light source may be any suitable source of photons at a visible wavelength (i.e., between about 400 nm and about 700 nm) and/or at an ultraviolet wavelength (i.e., between about 100 nm and about 400 nm). The light source may be naturally occurring (such as solar energy) or it may be from an artificial source (such as an LED light, an incandescent bulb, or the like). As the band gap for the BTO-based catalyst of the present disclosure is about 3 eV, it is capable of absorbing substantially all of the wavelengths of ultraviolent light below about 400 nm (as photons of ultraviolet light with frequencies between about 100 nm and about 400 nm have energies of between about 12.4 eV and 3.15 eV, respectively). However, when the catalyst is entirely, or substantially, submerged in the water, the water cannot be of a depth or turbidity that would significantly reduce the number of photons accessible to the catalyst. It is anticipated that the skilled person will be able to design and implement a device or apparatus that would allow for the catalyst to absorb photons, even when entirely, or substantially, submerged in the water, as demonstrated by the inventors in the examples provided below.

When conducting the methods described above, the illuminated catalyst may produce both oxygen gas and hydrogen gas from the water, or it may produce hydrogen gas and another oxygen-containing species, such as hydroxyl ions, hydroxyl radicals or superoxide radicals, for example. Typically these oxygen-containing species will remain in the water. Such species can alter the pH of the water or oxidise organic species. A preferred approach is to use the organic materials present in unpurified water sources to help suppress the formation of oxygen gas. As the cathodic and anodic reactions occur at the same site in this method (i.e., the surface of the NBT-based catalyst), when more than one gas is produced, they will be produced as a mixture (as opposed to a traditional electrolysis cell, whereby the cathode and anode are physically separated and so the two gases can also be physically separated). Whilst mixtures of hydrogen gas and oxygen gas may be preferred for some particular uses, such as in syngas or the production of certain chemicals when combined with a carbon source, such mixtures are generally avoided as they can be combustible, and pure products are usually more sought after. Accordingly, in a preferred embodiment, the hydrogen gas and oxygen gas are separated. The gasses may be separated shortly after leaving the water. Such separation may be carried out by any suitable method known in the art. For example, they may be separated by a specialized gas permeable membrane, or by preferentially dissolving the oxygen in water (as oxygen gas is more soluble in water), or one or both of the gasses may be further reacted to create a new product (such as the production of H₂O₂). In another preferred embodiment, a scavenger additive may be added to the water that prevents the formation of either the oxygen gas or the hydrogen gas in order to produce a pure, or at least purer, product. For instance, as the skilled person would be aware, an alcohol such as methanol or ethanol can be added to the water as a scavenger in order to prevent O₂ production. In one embodiment of this method, only hydrogen gas is produced, as the combined use of actinic radiation and vibrations bend the band gap such that the oxygen species remains in, or is dissolved in, the water.

### EXAMPLES

The present disclosure will now be described with referred to specific examples, which should not be construed as in any way limiting.

### Example 1—Catalyst Preparation and Characterisation

### Preparation

The raw BaTiO₃ nanopowders (BTO; reagent grade, 99 wt %) were purchased from Sigma-Aldrich (USA) [S&F note—supplier is only being provided here for “best method” requirements—we have no intention of limiting claims to suppliers]. A sample of 1 gram of powder was transferred to a loosely lidded alumina (Al₂O₃) crucible (1.5 mm H×5 mm L×2.5 mm W), placed in a Kanthal-wound muffle furnace, purged at room temperature for 1 hour, heated at a rate of 5° C./min, soaked at 800° C. for 12 hours, and cooled naturally. The purging, heating, and cooling were done at a gas flow rate of 50 cm³/min using O₂, N₂, Ar, or 5 vol % H₂+95 vol % N₂.

Accordingly, as used herein, catalysts prepared under an O₂ atmosphere are referred to as BTO-O, catalysts prepared under an N₂ atmosphere are referred to as BTO-N, catalysts prepared under an Ar atmosphere are referred to as BTO-A, and catalysts prepared under an H₂/Ar atmosphere are referred to as BTO-H.

A significant change in colour from white to dark grey was observed for the BTO-H particles compared to the other samples, which suggests a higher degree of reduction.

### Characterisation

The prepared particles were characterised using a range of techniques, as described below.

### XRD

Each of the BTO-O, BTO-N, BTO-A and BTO-H powders were characterized by X-ray diffraction (XRD; Aeris PANalytical Xpert Multipurpose X-ray diffractometer, UK; CuKα, 45 kV, 40 mA, 0.026° 2θ step size, 29.27° 2θ step speed). This data was supplemented by those from laser Raman microspectroscopy (Raman; Renishaw in Via confocal Raman microscope, Renishaw, UK; helium-neon green laser, diffraction grating 1800 grooves/mm) which was analysed using Renishaw WiRE 4.4 software and the spectra were calibrated against the silicon peak at ˜520 cm⁻¹).

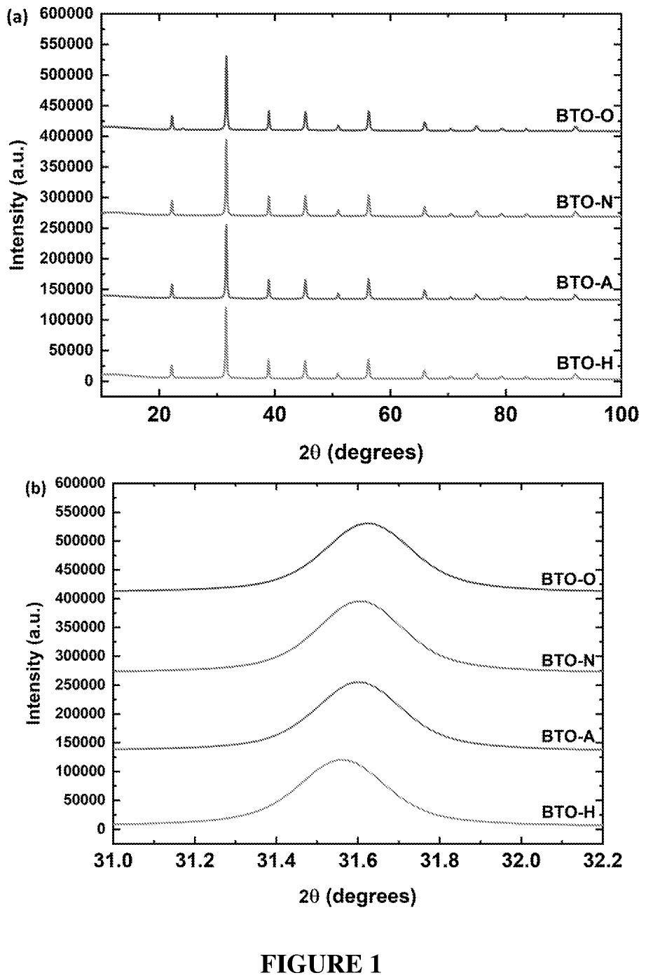

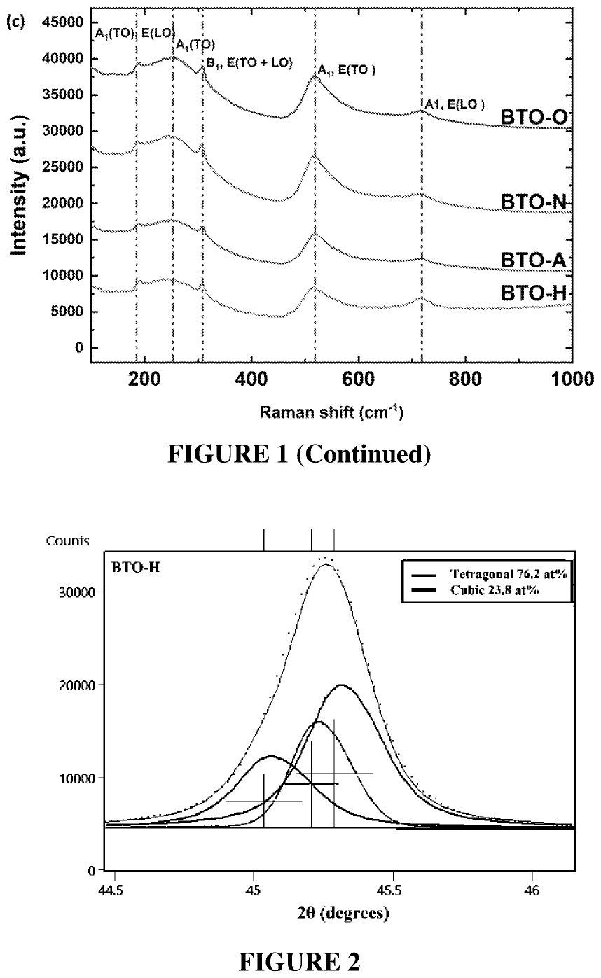

As seen in FIG. 1, the crystalline structures of BTO powders were investigated and confirmed using X-ray diffraction (XRD) analysis. As shown in FIG. 1(a), the diffraction peaks of all samples can be well indexed to known diffraction peaks for BaTiOs crystals. Further, the peak for the BTO-H sample appears to exhibit an obvious shift to a lower angle, shown in FIG. 1(b), which indicates lattice expansion. The shift could result from lattice distortion and associated destabilization or the formation of oxygen vacancies (V₀\ddot{ }) for the charge compensation. Further investigation of the structural changes was conducting using Raman spectroscopy; the data shows distortion of the lattice as presented in FIG. 1(c). The main spectral features observed included a small peak at 175 cm⁻¹ [A₁(TO), E(LO)], a broad peak centred at 265 cm⁻¹ [A₁TO], a relatively sharp peak at 306 cm⁻¹ [B₁, E(TO+LO)], a broad peak cantered at 520 cm⁻¹ [A₁, E(TO)] and an asymmetric broad peak centred at 720 cm⁻¹ [A₁, E(LO)]. As it has been well-established that ideal cubic BTO (Oₕ symmetry) is Raman inactive because of the isotropic distribution of electrostatic forces around Ti⁴⁺ ions, the appearance of strong Raman peaks corresponds to tetragonal BTO phase, which confirms the XRD analysis. From a structural point of view, piezoelectricity is the phenomenon of electronic/ionic polarization triggered by the off-centred displacement of the Ti⁴⁺ cations within the TiO₆ octahedra, accompanied by the lowered symmetry of the unit cell from cubic to tetragonal. Therefore, the distinct peaks observed should be assigned to the non-centrosymmetric ferroelectric characteristic of BTO nanoparticles, which is expected to give rise to the piezocatalytic effect.

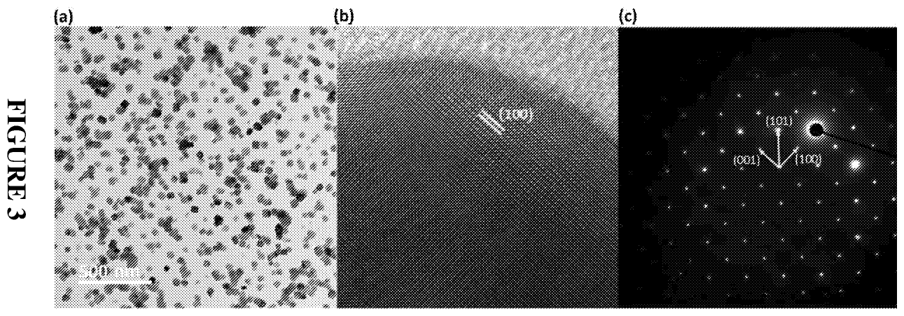

In the XRD Rietveld refinement data of the BTO-H sample shown in FIG. 2, the BTO (200) peak presents a shoulder on the lower angle side. It is known that the XRD pattern of cubic BTO shows a single peak at 2θ=45°, which agrees with the conventional cubic BTO Pm-3̅m structure of space group; however, peak splitting is observed at ˜2θ=45°, resulting in separated peaks representing (002) and (200) planes in tetragonal BTO when there is a phase transition. Thus, both cubic and tetragonal phases can be assumed to be present implying their coexistence in the perovskite structure.

### HRTEM

Further information of the crystallography was provided by high-resolution transmission electron microscopy (HRTEM). As shown in FIG. 3(a), the BTO nanoparticles (30-50 nm) with relatively uniform cubic shapes were obtained by 30 min sonication. The lattice fringes observed in the HRTEM were shown in FIG. 3(b) and extend throughout the individual grains, indicating that the grains are single crystals with high crystallinity. As determined from selected area electron diffraction (SAED) patterns shown in FIG. 3(c), the single crystal structure was indicated by the sharp and bright dots. In addition, the interplanar spacing of (001) planes are slightly larger than that of (100) planes, which confirms the existence of tetragonal symmetry of BTO nanoparticles.

### Particle Size, SEM, EDS

Further morphological and structural analyses of BTO nanoparticles were examined by Mastersizer 3000 and scanning electron microscope (SEM), energy-dispersive X-ray spectroscopy (EDS). The particle size distribution was determined by laser diffraction (Malvern Mastersizer 3000 laser diffraction particle size analyser, Malvern, UK). In a typical measurement, 100 mg of powder were dispersed in a 100 mL water using an ultrasonic bath for 10 min, after which the suspension analysed during stirring at 2,400 rpm. The specific surface area, pore volume, and average pore size were evaluated by the Brunauer-Emmett-Taller nitrogen adsorption method (BET; Quantachrome Autosorp 1MP, USA; 0.1 g sample, degassing for 1 h at 150° C.).

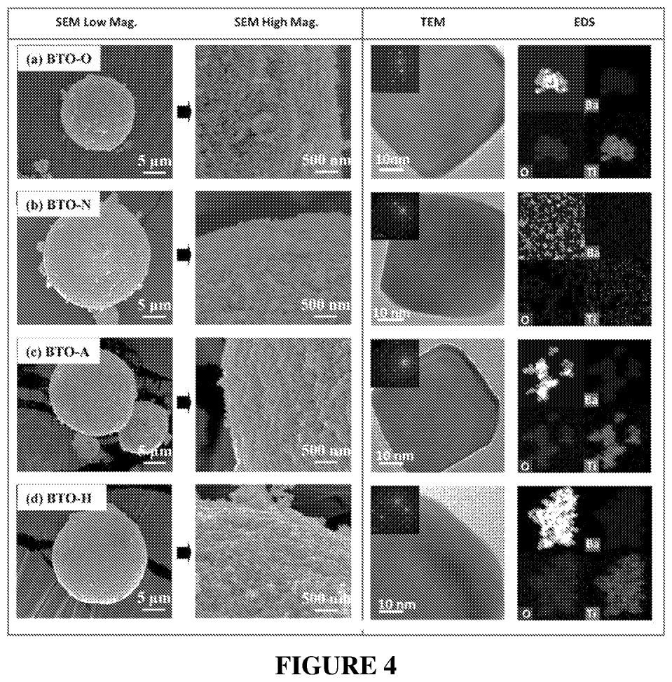

As shown in FIG. 4, the SEM images illustrates the nanosized cubic particles easily aggregates into micron-size-spherical cluster without the separation of long-time sonication. Even though the samples were dispersed in deionised water by sonication for 10 min prior to measurement, it is seen that a small fraction of the particles show sizes above 3 μm, which match with SEM images. Those micron-size particles are soft agglomerates that can be easily broken down into smaller nanosized cubic particles which are observed to be the major component in the particle size distribution with sizes ranging between 10-250 nm. However, there is still another small fraction of hard agglomerates with sizes between 1-2 μm, which have poor dispersion and are seen as large agglomerates in the HRTEM images. The EDS elemental mapping clearly indicates the presence of Ba, Ti, O elements which are uniformly distributed in the particles.

### Defects (EPR, PL, XPS)

The presence of defects was confirmed using electron paramagnetic resonance (EPR; Bruker EMX X-Band ESR Spectrometer, USA; constant frequency at 9.8 GHz). The processing of the EPR spectra was done using Bruker Xenon software. Qualitative analysis of defects was done using photoluminescence spectroscopy (PL; Shimadzu Spectro Fluorophotometer RF-5301PC, Japan; excitation wavelength 325 nm, room temperature). Quantitative analysis of defects was done using X-ray photoelectron spectroscopy (XPS; Thermo Scientific ESCALAB 250Xi X-ray Photoelectron Spectrometer Microprobe, UK; 13 kV, 12 mA, 500 μm spot size).

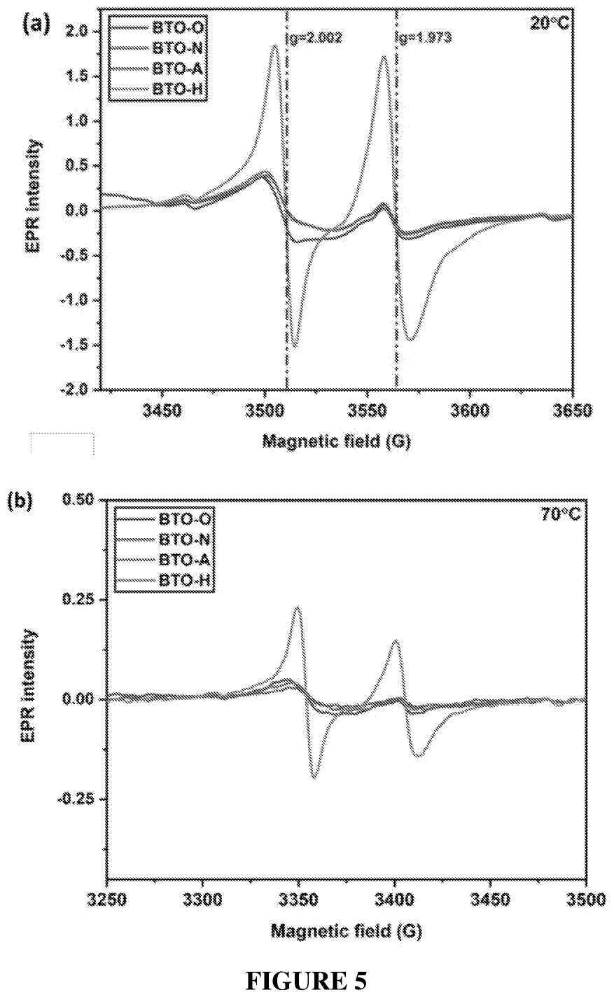

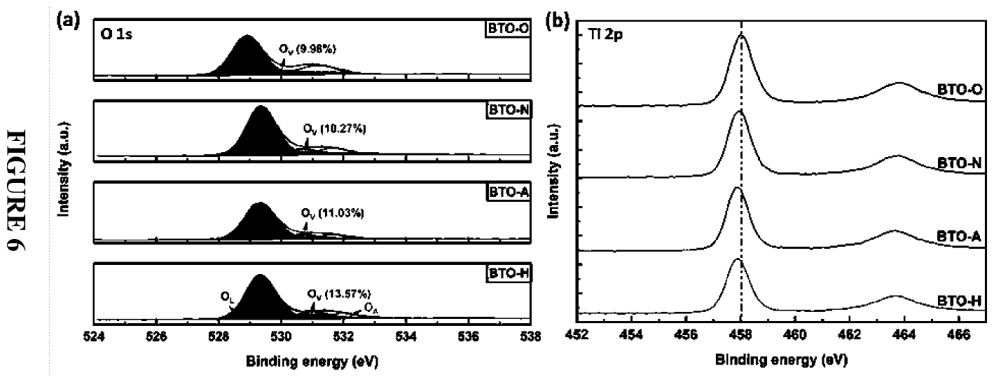

BTO has a typical perovskite structure (ABO₃) in the Pm3̅m tetragonal space group where Ba²⁺ occupies the A site and Ti⁴⁺ occupies the B site. As H₂ has a strong reduction capacity, it can remove oxygen atoms leading to the formation of oxygen vacancies that can trap one or two electrons in the form of small polarons. In such polarons, the electrons are localized on Ti atoms near the vacancies, which changes the Ti⁴⁺ to Ti³⁺, thereby forming a Ti³⁺-V_{O} dipole. FIG. 5(a) shows the room-temperature electron paramagnetic resonance (EPR) scan for the defective BTO nanoparticles to further investigate the defects within lattice. The signal at g=2.002 was assigned to surface absorbed superoxide radicals (⋅O₂⁻) and the signal at g=1.973 was assigned to the Ti³⁺-V_{O} complex. It could be noted that the signal increased significantly for the hydrogen reduced BTO, which confirms that the signal originates from the oxygen vacancies and Ti³⁺ defects. In order to detect the temperature dependence of EPR, the paramagnetic signals were measured of the same samples at 70° C. as shown in FIG. 5(b). At higher temperatures, owing to the relatively high conductivity, the electrons would spin at a higher speed in case the signal was attenuated. Therefore, an obvious lowering of the signal intensity was observed but the peaks representing the defect-related g-factors were consistent in terms of position which confirms the existence and stability of defects with increasing temperature.

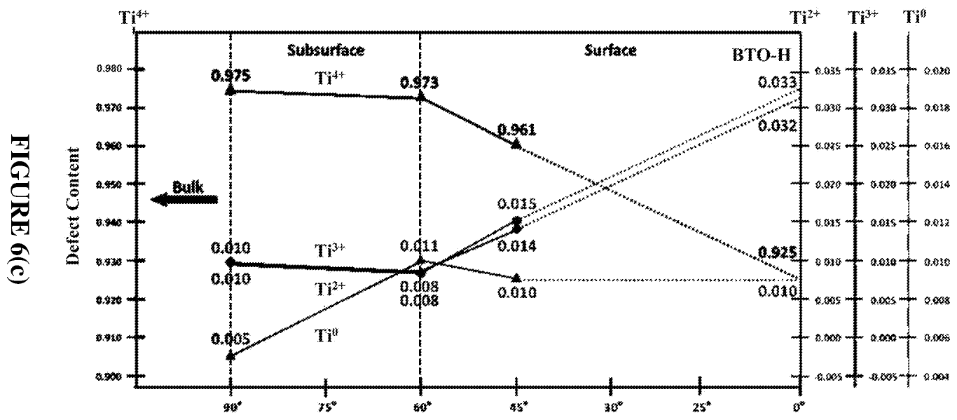

FIGS. 6(a) and 6(b) display the X-ray photoelectron spectroscopy (XPS) spectra for the BTO nanoparticles. The XPS spectra of the O 1s peak for BTO can be deconvoluted into three peaks of 529.6 eV, 530.9 eV, and 531.9 eV (denoted as O_{L}, O_{V} and O_{A}), which are ascribed to the lattice oxygen, the bonded oxygen in the oxygen deficient (V₀\ddot{ }) regions and adsorbed surface hydroxyl group oxygen, respectively. The O_{V}/(O_{L}+O_{V}+O_{C}) ratio (12.3 at %) was observed to be markedly higher for BTO-H compared to the other samples, i.e., BTO-O (9.1 at %), BTO-N (9.3 at %) and BTO-A (9.9 at %). This increase is consistent with the presence of structural defects on the surface (e.g., steps, kinks, and grain boundaries) formed in BTO-H during thermal reduction. In addition, the 530.2 eV peak assigned to the Ti³⁺—O, which is overlapped by the peak of O_{V}. The obvious shift of O_{V} peak in BTO-H to higher binding energy support this indication and the coexistence of Ti⁴⁺ and Ti³⁺. The XPS spectra of Ti 2p peaks at 458.10 eV (Ti 2p_{3/2}) and 463.90 eV (Ti 2p_{1/2}) confirm the presence of Ti⁴⁺. Comparison of BTO-O with BTO-H reveals that the Ti 2p peaks for the latter shifted to lower binding energies, which suggests the formation of less stable bonding configuration Ti³⁺—O—Ti³⁺ in the BTO lattice. The oxygen vacancy defects can result in midgap states capable of reducing the band gap. In addition, the intensities of Ti 2p peaks generally decreased indicating the decreasing Ti⁴⁺ level owing to the formation of Ti³⁺ by charge compensation. However, no obvious peaks for Ti³⁺ were detected, suggesting that, if it was present, it was at a low level below the limit of detection of the instrument (˜0.1 at %). It is also possible that limited reduction of Ti⁴⁺ to form Ti³⁺ may result from that Ti³⁺ was a transient phase. The specific reduction of Ti species in the BTO-H was further investigated using XPS to examine the distribution of Ti⁴⁺, Ti³⁺, Ti⁻²⁺ and Ti⁰ species in the material, starting at the surface and extending to the bulk. As can be seen from FIG. 6(c), there is a higher prevalence of reduced Ti species (i.e., Ti³⁺, Ti⁻²⁺ and Ti⁰) at the surface compared to the subsurface material.

FIG. 6(d) display the oxygen vacancy values (in at %) for a range of BTO nanoparticles that have been reduced by differing amounts, as measured using X-ray photoelectron spectroscopy (XPS) spectra. By varying the time that the BTO is exposed to the reducing atmosphere, a range of BTO nanoparticles are produced that range from white (i.e., minor treatment), through shade of grey to black, whereby the white sample has an L* value of about 0, and the black sample has an L* value of about 100. As can be seen from FIG. 6(d), the concentration of oxygen vacancies measured in these samples increases as the colour of the treated material darkens, indicating that the colour of reduced BTO is proportional to the colour material in greyscale.

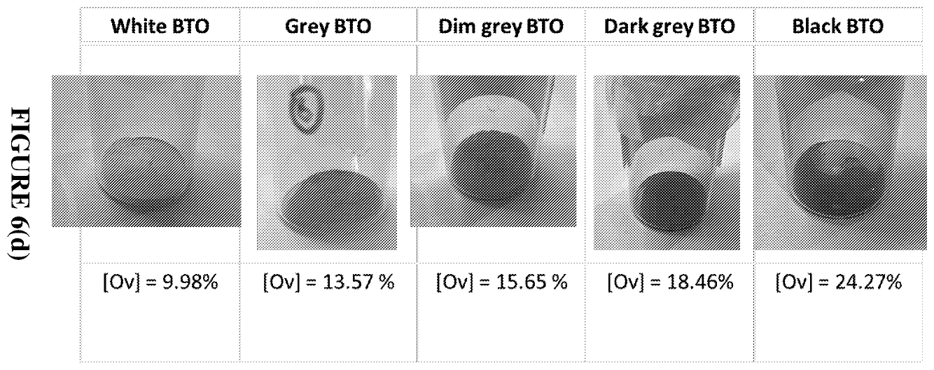

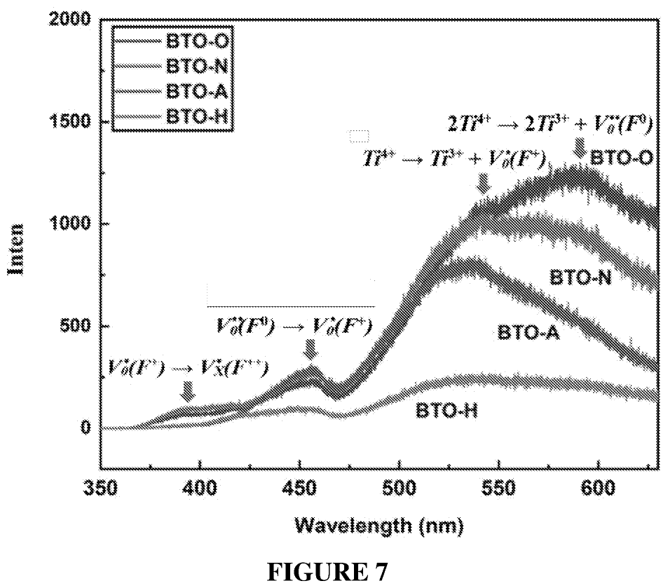

Photoluminescence (PL) can occur from the presence of point defects that generate energy transitions between ground and excited states associated with luminescent centres, which are often colour or F centres. It is generally agreed that the peak intensities are inversely proportional to the rates of electron-hole recombination and this has a significant effect on catalytic performance. The effect generally is controlled by the diffusion distance (i.e., particle size), the presence of trap states (i.e., defects), and the presence of heterojunctions (i.e., interfaces). FIG. 7 displays the PL spectra of BTO nanoparticles and the respective transitions, most of which are associated with the colour centres F⁰(V₀\ddot{ }), F⁺(V₀\dot{ }), and F⁺⁺(V₀^{μ}).

It was observed that all of spectra are comprised of broad peaks at 410 and 528.3 nm, which are attributed to the near band edge (NBE) and deep-level defect emissions (i.e., oxygen vacancies, surface states, OH⁻ defects and noncentral symmetric Ti³⁺ in the nanophase). The NBE and deep-level defect emissions are primarily attributed to the recombination of electron-hole pairs and the electron-trapped oxygen vacancies with BTO nanoparticles.

### Band Gap

The optical indirect (E_{g}) was determined using the absorption spectra obtained from UV-Vis spectrophotometry (UV-Vis; PerkinElmer Lambda 1050 UV-visible spectrophotometer, USA). The valence band level was determined using X-ray photoelectron spectroscopy and Ultraviolet photoelectron spectroscopy (UPS; Thermo Scientific ESCALAB 250Xi X-ray Photoelectron Spectrometer Microprobe, UK; 13 kV, 12 mA, 500 μm spot size). The work function was determined using amplitude-modulated Kelvin probe force microscopy equipped with a Nano Scope V Controller (AM-KPFM; Bruker Dimension ICON SPM, USA; SCM-PIT-V2 platinum-iridium coated AFM tip).

In order to calculate the full energy band levels, the band gaps (E_{g}) were determined by UV-Vis reflectance, the VBM (insets) were determined by XPS, and the CPD was determined by KPFM. From KPFM topography and contact potential difference of the BTO-H drop-cast film (FIG. 8(a) and FIG. 8(b)), it is seen that the particles were uniformly coated on the ITO substrate and the CPD was calculated as −173 mV. The Kubelka-Munk method was used to calculate the optical indirect band gap using the following equation:

$$( F ( {R}_{∞} ) h v ) = {A ( h v - {E}_{g} )}^{2} \qquad ( 1 )$$

where:
R_{∞}=Relative diffuse reflectance
h=Planck's constant
V=Frequency
A=Constant
E_{g}=Optical indirect band gap

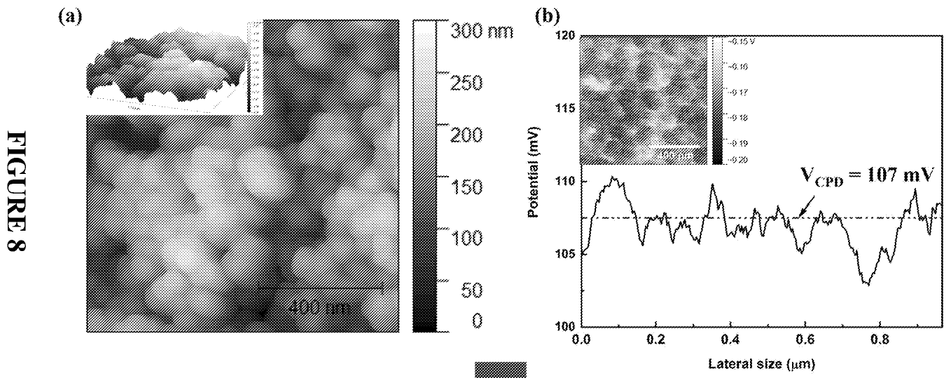

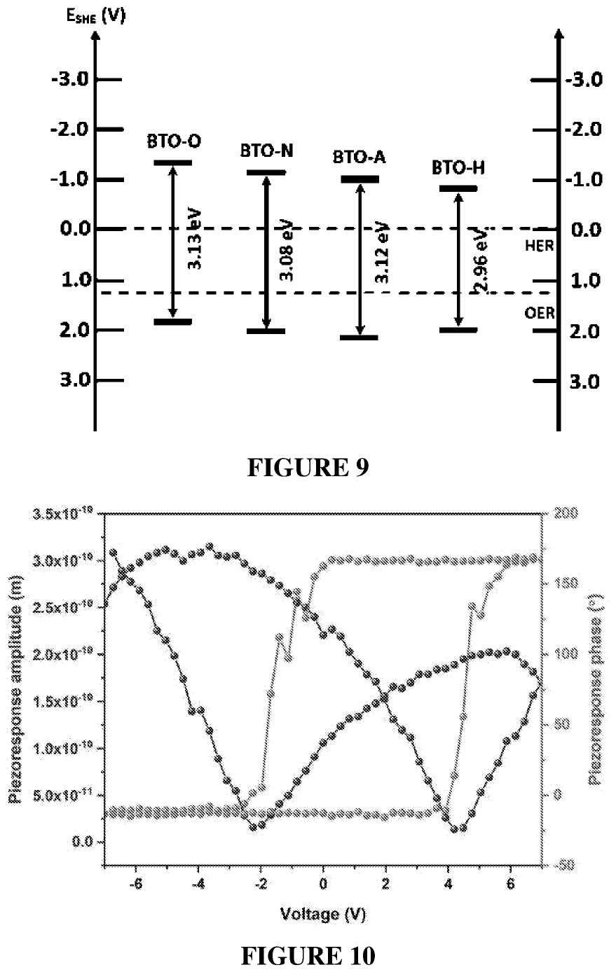

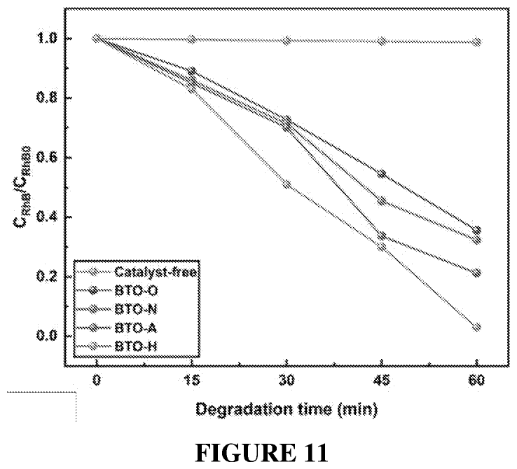

Based on the energy band level calculation, a schematic of the electronic band energy for the defective BTO nanoparticles was determined and this is shown in FIG. 9. The BTO annealed under O₂ shows a band gap of 3.13 eV and after reduction under H₂, there was a decrease to 2.96 eV. The reason for this lowering of the band gap is attributed to the presence of Oᵥ point defects and Ti³⁺ centres. The combination of these defects leads to specific electronic structure features, which are usually referred as trapped electrons. These states are expected to occur at ˜1.0 eV below the conduction band minimum (CBM), which induces band gap narrowing. A comparative analysis of XPS O1s peaks and their calculated ratios for all four BTO-x samples are provided below in Table 1.

TABLE 1
Comparative analysis of XPS O1s peaks and calculated
peak ratios for defective BTO nanoparticles.

| | BTO-O | BTO-N | BTO-A | BTO-H |
|---|---|---|---|---|
| XPS O1s peak | [at %] | [at %] | [at %] | [at %] |
| O_{L} | 38.32 | 41.49 | 42.99 | 41.35 |
| O_{V} | 4.25 | 4.75 | 5.33 | 6.49 |
| O_{A} | 10.84 | 5.22 | 4.90 | 4.70 |
| O_{V}/O_{L} + O_{V} | 9.98 | 10.27 | 11.03 | 13.57 |
| O_{V}/O_{L} + O_{V} + O_{A} | 7.96 | 9.23 | 10.02 | 12.35 |

### PFM

The piezoelectric amplitude, hysteresis, topography, and phase were determined using piezo-response force microscopy (PFM; Asylum Research, MFP-3D-SA, USA) in contact mode. By applying a tip bias of ±7 V, the PFM amplitude-voltage butterfly curve and phase-voltage hysteresis loop of the sample BTO-H were determined, and these are shown in FIG. 10. The butterfly-shaped curve appears symmetrical, indicating decent piezoelectric properties. Further, the phase hysteresis loop presents about 180° domain switching at ±7 V, which is the most important evidence that the BTO-H exhibits strong ferroelectric response, inducing a high piezocatalytic activity. The polarization bound charges on the crystal surface will form a depolarization field that requires screening from the free space charges.

### Example 2—Hydrogen Generation

Another desired use for the BTO-based catalyst of the present disclosure is the generation of hydrogen gas from water (so-called “water splitting”). It is well known in the art that hydrogen gas is produced during catalysed water splitting reactions via the hydrogen evolution reaction (HER). The HER data was obtained using a 150 mL off-line Pyrex top-illumination reactor, the opening of which was sealed with sleeve-stopper septum. For each run, 100 mg of the BTO-based catalyst powder was added to 100 mL of deionised water, simulated seawater (0.35 g NaCl in 1 L water), or natural seawater (obtained from Coogee Beach, Sydney, Australia), after which they were loaded into the reactor. To examine the piezocatalytic ability to generate hydrogen gas, the suspensions inside the cell then were dispersed using an ultrasonic bath (Hwashin, 100-510-240; Korea; 40 kHz, 400 W, 15 min). The gaseous contents of the cell then were removed by purging with argon at a gas flow rate of 15 cm³/min. The testing consisted of sonication of each suspension in the same ultrasonic batch but at power levels of 280 W, 330 W, or 400 W for between 1 and 5 h. A gas sample of volume 1 mL generated above the solution was extracted at each hour during sonication by piercing the septum using a syringe. These samples subsequently were analysed chemically by gas chromatography (Shimadzu GC 8A Gas Chromatograph, Japan).

To measure the photocatalytic ability to generate hydrogen gas, the same procedure as described above for piezocatalysis was carried out, except that, instead of sonication, irradiation was done using a 300 W Xenon lamp with a 420 nm cut-off filter as the all-spectrum light source.

Further, to measure the piezophotocatalytic ability to produce hydrogen gas, the same procedure as described above for piezocatalysis and photocatalysis was carried out, except the suspension was exposed to both UV light and sonication. In order to further examine the combined effects of UV light and sonication, experiments were carried out whereby the sample was exposed to just UV light first (for a period of 2 hours), and then sonication was applied in combination with the UV light (for a period of three hours), with the relative rates of production of hydrogen gas examined.

The reaction mix showed an increased production rate of hydrogen with the combined application of light and ultrasound, compared with the application of light or ultrasound alone.

| Test Condition | Hydrogen Production Rate (μmol/g/h) |
|---|---|
| Light Only | 0 |
| Sonication Only | 96.9 |
| Sonication plus Light | 132.4 |

When tested with sea water, the hydrogen production rate was reduced by just over 50% but still of useful rate. Reducing the sonication power also reduced hydrogen production.

In contrast, a reaction mix comprising unmodified white BaTiO₃ powder did not produce hydrogen when tested under similar conditions.

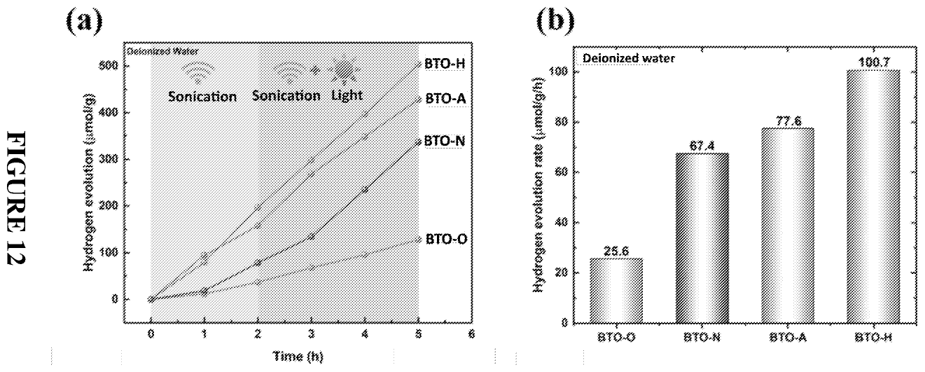

Shown in FIG. 12(a) is the results of a catalytic hydrogen generation experiment (2 hours of sonication only then 3 hours of sonication and irradiation) as described above. As can be seen from this figure, the total hydrogen production for 5 h per 100 mg of catalyst follows the order: BTO-O<BTO-N<BTO-A<BTO-H. This result confirms that the highest piezophotocatalytic hydrogen generation activity can be obtained by inducing the highest concentration of defects in the BTO-based catalyst (i.e., Oᵥ and Ti³⁺ that are present in BTO-H). In addition, FIG. 12(a) clearly shows that the hydrogen production increased almost linearly with the increase of processing time, indicating hydrogen was produced at a constant rate, which are shown in FIG. 12(b).

Further, the effect of water type (deionized water, simulated seawater and natural seawater) on piezophotocatalytic hydrogen production was investigated to detect its potential for commercial seawater splitting. Table 2 summarizes the changes in pH and elemental concentrations before and after the piezo-photocatalytic hydrogen evolution. It is found that, compared to the simulated seawater (˜35 wt % NaCl solution), the natural seawater (from Coogee beach, Australia) has slightly higher salinity and contains a mixture of salts (electrolytes) such as K⁺, Mg²⁺, Ca²⁺, S²⁻, as well as suspended inorganic and organic matter.

TABLE 2
Summary of pH and ICP-OES elemental analyses of different waters before
and after the piezophotocatalytic hydrogen evolution reaction.

| | | | | | | | | |
|---|---|---|---|---|---|---|---|---|
| | | Na | Cl | K | Mg | Ca | S | C |
| | | mg/L | mg/L | mg/L | mg/L | mg/L | mg/L | mg/L |
| Water Type | pH | (ppm) | (ppm) | (ppm) | (ppm) | (ppm) | (ppm) | (ppm) |

Analysis before piezophotocatalytic HER

| | | | | | | | | |
|---|---|---|---|---|---|---|---|---|
| Deionized | 7.44 | 0.00 | 0.00 | 0.00 | 0.00 | 0.00 | 0.00 | 0.00 |
| water | | | | | | | | |
| Simulated | 5.30 | 11020.97 | 15916.45 | 7.00 | 0.10 | 0.79 | 0.05 | 0.00 |
| Seawater | | | | | | | | |
| Natural | 5.84 | 11186.97 | 18900.45 | 396.80 | 1496.00 | 441.00 | 925.00 | 24.27 |
| Seawater | | | | | | | | |

Analysis after piezophotocatalytic HER

| | | | | | | | | |
|---|---|---|---|---|---|---|---|---|
| Deionized | 8.38 | 0.26 | 0.16 | 0.00 | 0.00 | 0.00 | 0.00 | 0.00 |
| water | | | | | | | | |
| Simulated | 6.04 | 11083.97 | 19958.45 | 10.10 | 0.08 | 0.47 | 0.86 | 5.55 |
| Seawater | | | | | | | | |
| Natural | 6.20 | 11532.00 | 23159.45 | 399.30 | 1493.00 | 433.00 | 925.99 | 25.77 |
| Seawater | | | | | | | | |

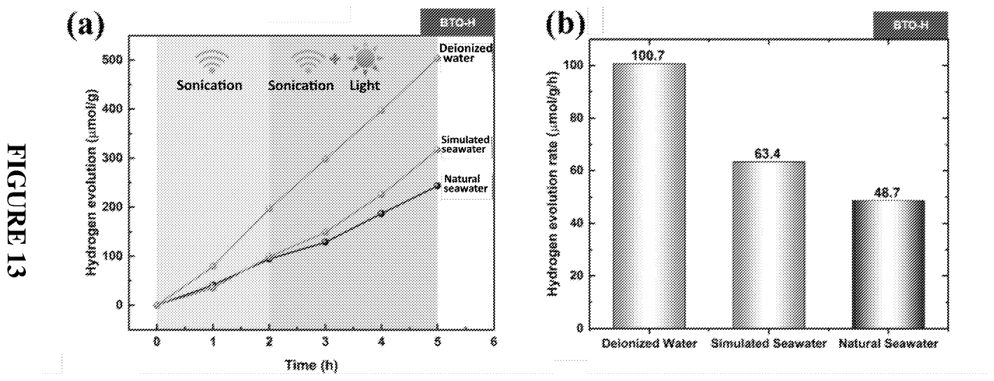

FIGS. 13(a) and 13(b) show hydrogen production of BTO-H with deionized water, simulated seawater and natural seawater, respectively. Hydrogen was produced steadily in all cases, but it is clearly noted that the H₂ production rate from simulated seawater (63.4 μmol/g/h) was lower than that from deionized water (100.7 μmol/g/h). The lowering of the HER is attributed to the presence of dissolved Cl⁻ in simulated seawater, which is understood to have a negative effect owing to its role in scavenging charge carriers and blocking surface active sites. The further lowering of the performance in natural seawater is believed to result from the presence of the more complex aqueous environment which contains multiple ions, for instance it is understood that Mg²⁺ can lower the HER performance of similar catalysts via chelation of Mg²⁺ that blocks the separation of the photogenerated electron-hole and induces the charge redistribution, thereby negatively impacting the photocatalytic performance. Similarly, it is understood that the presence of sulfide and sulfite ions may reduce the HER performance of the catalyst as it can cause a charge imbalance in the solution, impeding their function as sacrificial agents resulting in the formation of precipitates. Additionally, one of the challenges of using a natural water source such as seawater is the presence of organic matter and microorganisms that may cause some unexpected side reactions and may minimize the H₂ production rate as well.

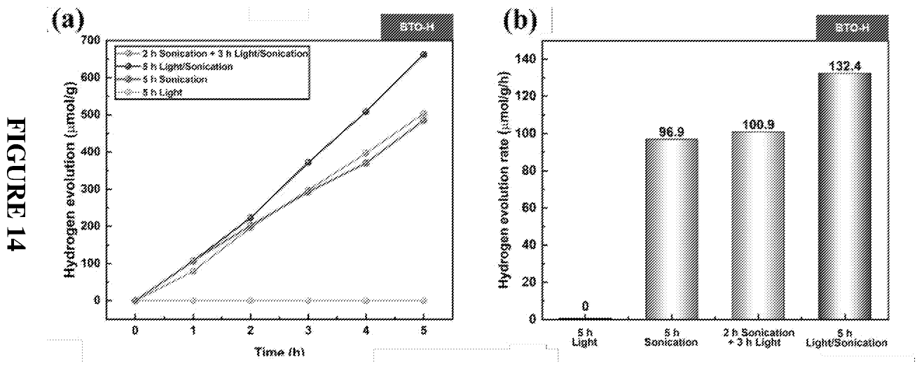

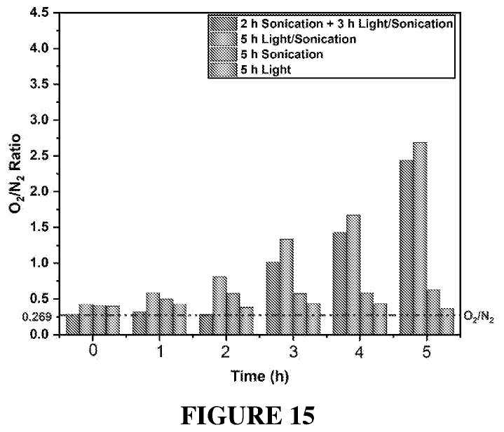

FIGS. 14(a) and 14(b) show H₂ production rates under different experimental conditions, including (i) 5 hours irradiation only, (ii) 5 hours sonication only, (iii) 2 hours sonication followed by 3 hours combination of sonication plus irradiation, and (iv) 5 hours sonication plus irradiation. It is noted that no H₂ was generated under only UV light irradiation, which could be interpreted in terms of the rapid charge carrier recombination of perovskite-type materials (such as BTO). However, this low photocatalytic activity is activated by ultrasonic agitation, which enables the continual separation of electron-hole pairs, which suppresses the recombination of charge carriers. The same effect is also reflected in the OER reaction, with the O₂ production rates shown in FIG. 15. The inventors note that, when the BTO-based catalysts are exposed to both ultrasound irradiation and all-spectrum light irradiation simultaneously, the catalytic H₂ and O₂ production rates are the highest when compared to the production rates under either ultrasound irradiation or light irradiation alone.

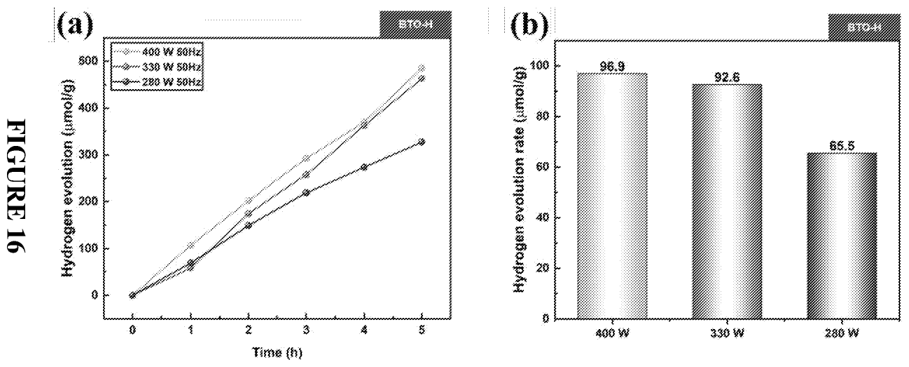

After establishing above that vibrational energy is important in providing the highest possible rates of hydrogen gas production, FIGS. 16(a) and 16(b) show the effect of vibration power on the photocatalytic hydrogen production. The hydrogen production rate of a BTO-H sample under the vibration power of 280 W is about 65.5 μmol/g/h, which is significantly less than the rates observed with higher vibration powers of 330 W and 400 W. It is understood that the relationship between piezoelectric charge (Q) per unit area, the piezoelectric coefficient (d) and the external stress (T) can be described as Q=dT. Therefore, it is understandable that a higher vibration power can lead to higher external mechanical stresses, which therefore induces more piezoelectric charges on the catalysts surface, resulting in greater rates of hydrogen production. The inventors also understand that as the generated surface piezoelectric charges are localized and tightly bonded, consequently the charges will vanish rapidly due to quick relaxation of mechanical stress, which supports the hypothesis that dominate resources of free charges in piezophotocatalytic hydrogen production comes from vibrational energy sources.

### Discussion

Based on the above results, the different photocatalytic, piezocatalytic and photo/piezocatalytic hydrogen evolution reaction mechanisms are hypothesised. The inventors believe that when the defective BTO is under visible light irradiation only, the electrons are excited from the VB to the CB, with holes generated on the VB. However, the rapid recombination of these separate electron-hole pairs can more easily occur, thereby inhibiting the migration of generated carriers to the catalyst surface and further participation in reduction/oxidation reactions.

When the defective BTO is subjected to ultrasonication alone, it is believed that the mechanical force can directly excite the electrons from the VB to the CB as the collapse of ultrasonic-induced cavitation bubbles can inflict a high local pressure of up to 10⁸ Pa at the catalyst-water heterogeneous interface, which supplies sufficient energy activation for electron excitation. Distinct from photocatalysis, the piezo-induced charge separation shows a much greater amount of charge separation, which significantly hinders the recombination of charge carriers. The generated electrons and holes can then be attracted to the two contrary polar surfaces of the catalyst separately through electrostatic interactions, which results in a phenomenon known as band bending. It should be noted that the band edge of BTO-H is theoretically not favourable for water splitting because the VB and CB of the catalyst do not exceed the free energy of water splitting (which may explain the lack of hydrogen generation for BTO-H when irradiated only with light in FIG. 21(a)). However, due to band bending caused by the piezopotential, the band position of CB is much closer to the redox potential (0 V for H⁺/H₂) and the band position of VB is further away from the redox potential (1.23 V for H₂O/O₂). Therefore, BTO (and particularly BTO-H) can easily trigger the redox reactions required to generate H₂ while OH ions remain in the solution and do not contribute to O₂ production. In addition, the existing Ti³⁺ defects in the lattice or surface of BTO-H are unstable and easily oxidise to stable Ti⁴⁺, but the continuing free carriers provided by the piezoelectric effect will suppress the oxidation process, leading to a permanent retention of these defects in the lattice. Further, when the defective BTO (especially BTO-H) is subjected to both ultrasonication and light irradiation, the photocatalysis is activated as the rapid recombination of charge carriers is suppressed by the piezo-induced charge carriers. As a result, negligible O₂ production was observed during the piezo-induced band bending, as the photocatalytic HER will utilize some localized electrons. Finally, it can be concluded that the efficient separation of force generated electrons-hole pairs and favourable band edge caused by band bending can accelerate the catalytic hydrogen production.

Although the disclosure has been described with reference to specific examples, it will be appreciated by those skilled in the art that the disclosure may be embodied in many other forms in particular features of any one of the various described examples may be provided in any combination in any of the other described examples. Various modifications and alterations to this disclosure will become apparent to those skilled in the art without departing from the scope and spirit of this disclosure. It should be understood that this disclosure is not intended to be unduly limited by the illustrative embodiments and examples set forth herein.

1. A piezo photocatalytic process for the production of hydrogen from water, wherein the process comprises the steps of:
(a) providing non-metal-doped barium titanate which includes at least one defect;
(b) contacting the non-metal-doped barium titanate provided in step (a) with water to form a mixture; and
(c) subjecting the mixture formed in step (b) to:
(i) actinic radiation; and
(ii) mechanical force,
to produce hydrogen from the water.

2. The process according to claim 1, wherein the at least one defect is an oxygen vacancy and/or a reduced Ti ion (Ti^{<4+}), or a combination thereof.

3. The process according to claim 1 or claim 2, wherein the non-metal-doped barium titanate comprises oxygen vacancies at a concentration of up to about 25 at %.

4. The process according to claim 2, wherein the or each reduced Ti ion (Ti^{<4+}) is Ti³⁺, Ti²⁺ and Ti⁰.

5. The process according to any one of claims 1 to 4, wherein the non-metal-doped barium titanate has a molar ratio of Ti⁴⁺:Ti^{<4+} of from 5.0:1 to 15:1.

6. The process according to any one of claims 1 to 5, wherein the non-metal-doped barium titanate is in the form of a nano-composite, wherein the nano-composite comprises a mixture of cubic and tetragonal phases.

7. The process according to claim 6, wherein the tetragonal phase is in the form of inclusions which are embedded in the cubic phase.

8. The process according to claim 7, wherein greater than 50 vol % of the nano-composite is in the tetragonal phase.

9. The process according to any one of claims 1 to 8, wherein the water used in step (b) is sea water.

10. The process according to any one of the preceding claims, wherein during step (b) the mixture is subjected substantially simultaneously to:
(i) actinic radiation; and
(ii) mechanical force.

11. The process according to any one of the preceding claims, wherein the non-metal-doped barium titanate has a band gap of equal to or less than 3 eV.

12. The process according to claim 11, wherein the band gap is defined by a CB that is greater than 0 eV and a VB that is less than 1.23 eV.

13. The process according to any one of the preceding claims, wherein the actinic radiation in step (c) is ultra-violet radiation.

14. The process according to any one of the preceding claims, wherein the mechanical force in step (c) is ultrasound.

15. A process for producing a non-metal-doped barium titanate, wherein the process comprises the steps of:
(i) providing non-metal-doped white barium titanate,
wherein the non-metal-doped white barium titanate comprises Ti⁴⁺, and
wherein greater than 90 wt % of the non-metal-doped white barium titanate is in the cubic phase and
wherein the non-metal-doped white barium titanate obtained in step (i) has a white colour such that the L* value is in the range of from 70 to 99; and
(ii) contacting the non-metal-doped white barium titanate from step (a) with hydrogen gas, wherein step (ii) is carried out at a temperature (t) in the range of from 600° C. to 1100° C., a hydrogen concentration (c) in the range 3.0 v/v % to 100 v/v %, and for a duration (d) in the range 1.0 hr to 15 hours,
to form non-metal-doped barium titanate wherein the non-metal-doped barium titanate has a grey colour such that the L* value is in the range of from 5.0 to 70 and the b* value is greater than −5.0,
wherein the non-metal-doped barium titanate has a molar ratio of Ti⁴⁺:Ti^{<4+} of from 5.0:1 to 15:1,
wherein the non-metal-doped barium titanate is in the form of a nano composite,
wherein the nano-composite comprises a mixture of cubic and tetragonal phases,
wherein the tetragonal phase is in the form of inclusions which are embedded in the cubic phase, and
wherein greater than 50 wt % of the nano-composite is in the tetragonal phase.

16. A process according to claims 15, wherein the hydrogen concentration (c) is below the flammability limit.

17. A non-metal-doped barium titanate,
wherein the non-metal-doped barium titanate has a molar ratio of Ti⁴⁺:Ti^{<4+} of from 5.0:1 to 15:1,
wherein the non-metal-doped barium titanate is in the form of a nano-composite, wherein the nano-composite comprises a mixture of cubic and tetragonal phases, wherein the tetragonal phase is in the form of inclusions which are embedded in the cubic phase, and
wherein greater than 50 wt % of the nano-composite is in the tetragonal phase.

18. A non-metal-doped barium titanate according to claim 17, wherein the non-metal-doped barium titanate has a band gap equal to or less than 3.0 eV and a fermi level of from 0.35 to 0.

19. A non-metal-doped barium titanate according to claim 17 or 18, wherein the non-metal-doped barium titanate has a grey colour such that the L* value is from 5.0 to 70 and the b* value is greater than −5.0.

20. A piezo photocatalytic process for the production of hydrogen from water according to any of claims 1-14,
wherein the non-metal-doped barium titanate provided in step (a) is obtained by a process according to claim 15 or 16, and
wherein the non-metal-doped barium titanate provided in step (a) is a non-metal-doped barium titanate according to any of claims 17-19.
